(19) United States
(12) Patent Application Publication
(10) Pub. No.: US 2025/0220540 A1
(43) Pub. Date: Jul. 3, 2025

(54) Access Point Assisted Handover for Ultra-Wideband Ranging

(71) Applicant: Cisco Technology, Inc., San Jose, CA (US)

(72) Inventors: Jerome Henry, Pittsboro, NC (US); Vinay Saini, Bangalore (IN); Peiman Amini, Fremont, CA (US); Ardalan Alizadeh, Campbell, CA (US); Robert Barton, VANCOUVER (CA)

(21) Appl. No.: 18/932,375

(22) Filed: Oct. 30, 2024

(30) Foreign Application Priority Data
Dec. 28, 2023 (IN) IN202341089445

(51) Int. Cl. H04W 36/30; G01S 13/74; H04W 36/00; H04W 36/08; H04W 84/12

(52) U.S. Cl. CPC H04W 36/302; H04W 36/0061; H04W 36/0079; H04W 36/08; G01S 13/74; H04W 84/12

(57) ABSTRACT

Devices, networks, systems, methods, and processes for providing Ultra-Wideband (UWB) handover recommendations to a client device are provided herein. In order to provide a UWB handover recommendation, a network device may perform a UWB ranging operation against the client device. Upon performing the UWB ranging operation, the network device may select a UWB-enabled AP for a subsequent UWB ranging operation. Further, the network device may transmit, to the client device, the UWB handover recommendation including an indication of a proposed handover to the UWB-enabled AP in order to inform the client device about the UWB-enabled AP. Accordingly, the client device may not struggle in identifying and selecting the UWB-enabled AP for performing the subsequent UWB ranging operation.

The present disclosure relates to wireless networks. More particularly, the present disclosure relates to providing Ultra-Wideband (UWB) handover recommendations for UWB ranging by utilizing one or more wireless technologies supported by access points.

This application claims the benefit of Indian Provisional Patent Application No. IN202341089445, filed Dec. 28, 2023, which is incorporated by reference herein in its entirety.

### BACKGROUND

Networking architectures have become increasingly complex, particularly in mobile communication environments. In many cases, determining the precise location of a mobile device within these environments is essential. While various wireless technologies, such as IEEE 802.11 (e.g., Wi-Fi) and Bluetooth, offer location-based services, they often provide limited accuracy. This lack of precision can be problematic in applications that require more precise location data, such as asset tracking or indoor navigation.

Ultra-Wideband (UWB) technology, as defined by IEEE standards 802.15.4a and 802.15.4z, offers a considerable improvement in location accuracy over Bluetooth and Wi-Fi. UWB's high time resolution enables it to deliver more precise location measurements, especially in short-range environments. A commonly used UWB positioning technique is Time Difference of Arrival (TDoA), in which a mobile device listens to signals exchanged by multiple UWB anchors and determines its position based on the time differences between when these signals arrive at the UWB anchors. To determine a two-dimensional (2D) position, the mobile device should detect signals from at least three UWB anchors, and for three-dimensional (3D) positioning, the mobile device should detect signals from at least four UWB anchors.

However, one challenge that UWB technology faces is that UWB range is shorter than that of other wireless technologies such as Wi-Fi or Bluetooth. In practice, mobile devices often detect signals from only one or two UWB anchors, making TDoA unfeasible in many cases. To address the shortcomings of TDoA, UWB also supports a technique called Two-Way Ranging (TWR). In TWR, the mobile device can directly exchange messages with individual UWB anchors, measuring the round-trip time of the signal to determine the distance to each anchor. This method can provide accurate distance measurements and works well even when the mobile device can only communicate with one anchor at a time.

Although TWR addresses the range limitations in UWB ranging, it introduces many new challenges. For example, TWR does not provide guidance on how the mobile device should identify and select additional UWB anchors for subsequent ranging. As a result, once a connection is made with one anchor, the mobile device may struggle to locate or range with other nearby anchors, complicating the process of determining its position. Despite the theoretical advantages UWB offers in location accuracy, practical limitations related to range and anchor detection create significant challenges in determining precise mobile device locations in real-world scenarios.

### SUMMARY OF THE DISCLOSURE

Systems and methods for providing Ultra-Wideband (UWB) handover recommendations for UWB ranging by utilizing one or more wireless technologies supported by access points in accordance with embodiments of the disclosure are described herein. In many embodiments, a network device may include a processor, a network interface controller configured to provide access to a network, and a memory communicatively coupled to the processor. The memory may include a localization logic that is configured to perform an Ultra-Wideband (UWB) ranging operation against a client device. The localization logic may further be configured to transmit, to the client device, an indication of a proposed handover to a first UWB-enabled Access Point (AP) for a subsequent UWB ranging operation.

In a number of embodiments, the UWB ranging operation may include a Two-Way Ranging (TWR) operation.

In a variety of embodiments, the UWB ranging operation may include two or more rounds of ranging exchanges.

In various embodiments, the localization logic may further be configured to determine a movement vector of the client device relative to the network device based on the two or more rounds of ranging exchanges.

In more embodiments, the localization logic may further be configured to determine at least one distance between the client device and the network device based on the UWB ranging operation.

In additional embodiments, the localization logic may further be configured to measure at least one Wireless Local Area Network (WLAN) Received Signal Strength Indicator (RSSI) associated with the client device, and establish a correspondence relationship between the at least one WLAN RSSI associated with the client device and the at least one distance between the client device and the network device.

In further embodiments, the indication of the proposed handover may be transmitted via a Wireless Local Area Network (WLAN) action frame.

In still more embodiments, the indication of the proposed handover may include a UWB identifier associated with the first UWB-enabled AP.

In still further embodiments, the indication of the proposed handover may further include an indication of a Wireless Local Area Network (WLAN) Received Signal Strength Indicator (RSSI) threshold.

In still additional embodiments, the localization logic may further be configured to compile a neighbor AP list based on a Neighbor Discovery Protocol (NDP), and select the first UWB-enabled AP from the neighbor AP list for the proposed handover.

In some more embodiments, the localization logic may further be configured to receive, from the client device, an indication of a failure of the proposed handover to the first UWB-enabled AP, update the neighbor AP list based on the failure of the proposed handover to the first UWB-enabled AP, select a second UWB-enabled AP from the updated neighbor AP list, and transmit, to the client device, an indication of an additional proposed handover to the second UWB-enabled AP for the subsequent UWB ranging operation.

In yet various embodiments, the localization logic may further be configured to determine a success of the proposed handover of the client device to the first UWB-enabled AP based on an absence of an indication of a failure of the proposed handover, and update the neighbor AP list based on the success of the proposed handover to the first UWB-enabled AP.

In yet more embodiments, the localization logic may further be configured to utilize a machine learning process to update the neighbor AP list and select one or more further UWB-enabled APs from the updated neighbor AP list for one or more further proposed handovers.

In still yet more embodiments, the network device may include a UWB-enabled AP.

In many further embodiments, a client device may include a processor, a network interface controller configured to provide access to a network, and a memory communicatively coupled to the processor. The memory may include a localization logic that is configured to detect a presence of a first Ultra-Wideband (UWB)-enabled Access Point (AP), perform a UWB ranging operation against the first UWB-enabled AP, and receive an indication of a proposed handover to a second UWB-enabled AP for a subsequent UWB ranging operation from the first UWB-enabled AP.

In many additional embodiments, the localization logic may further be configured to receive an indication of the first UWB-enabled AP via an Out of Band (OOB) process.

In still yet further embodiments, the indication of the first UWB-enabled AP may include a UWB identifier associated with the first UWB-enabled AP and an indication of a Wireless Local Area Network (WLAN) Received Signal Strength Indicator (RSSI) threshold, where the localization logic may further be configured to measure one or more WLAN RSSIs associated with the first UWB-enabled AP; and compare each of the measured one or more WLAN RSSIs associated with the first UWB-enabled AP to the WLAN RSSI threshold, and where the UWB ranging operation may be performed in response to at least one of the measured one or more WLAN RSSIs associated with the first UWB-enabled AP being greater than the WLAN RSSI threshold.

In still yet additional embodiments, the localization logic may further be configured to perform the subsequent UWB ranging operation against the second UWB-enabled AP based on the indication of the proposed handover, and receive an indication of a subsequent proposed handover to a third UWB-enabled AP for a next UWB ranging operation from the second UWB-enabled AP.

In several embodiments, the localization logic may further be configured to attempt to perform the subsequent UWB ranging operation against the second UWB-enabled AP based on the indication of the proposed handover, where the attempt may result in a failure, transmit, to the first UWB-enabled AP, an indication of the failure of the proposed handover to the second UWB-enabled AP, and receive an indication of an additional proposed handover to a third UWB-enabled AP for the subsequent UWB ranging operation from the first UWB-enabled AP based on the indication of the failure of the proposed handover to the second UWB-enabled AP.

In several more embodiments, a method for handing over a client device may include performing an Ultra-Wideband (UWB) ranging operation against the client device, and transmitting, to the client device, an indication of a proposed handover to a UWB-enabled Access Point (AP) for a subsequent UWB ranging operation.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a localization logic can operate on a plurality of network devices in accordance with various embodiments of the disclosure;

FIG. 2 is an exemplary network environment for implementing the localization logic in accordance with various embodiments of the disclosure;

FIG. 3 is an exemplary network environment for providing Ultra-Wideband (UWB) handover recommendations in accordance with various embodiments of the disclosure;

FIG. 4 is a conceptual process flow diagram for performing multiple UWB ranging operations in accordance with various embodiments of the disclosure;

FIG. 5 is a diagram depicting various subsets of artificial intelligence in accordance with various embodiments of the disclosure;

FIG. 6 illustrates different methods of machine-based learning in accordance with various embodiments of the disclosure;

FIG. 7 is a machine learning lifecycle in accordance with various embodiments of the disclosure;

FIG. 8 is an exemplary neural network 16800 in accordance with various embodiments of the disclosure;

FIG. 9 is a flowchart depicting a process for transmitting a proposed handover indication in accordance with various embodiments of the disclosure;

FIG. 10 is a flowchart depicting a process for handing over a client device in accordance with various embodiments of the disclosure;

FIG. 11 is a flowchart depicting a process for transmitting an additional proposed handover indication in accordance with various embodiments of the disclosure;

FIG. 12 is a flowchart depicting a process for receiving the proposed handover indication in accordance with various embodiments of the disclosure;

FIG. 13 is a flowchart depicting a process for receiving the additional proposed handover indication in accordance with various embodiments of the disclosure; and

FIG. 14 is a conceptual block diagram of a device suitable for configuration with the localization logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for providing Ultra-Wideband (UWB) handover recommendations to a client device by utilizing one or more wireless technologies supported by a network device. As used herein, the network device may include an access point (AP) that supports the wireless technologies (e.g., Wi-Fi, Bluetooth, or the like) for allowing one or more client devices to connect to the Internet or other client devices. Additionally, the AP may support a UWB technology for various applications such as location tracking, object detection, or the like. Hereinafter, the AP that supports the UWB technology may be referred to as a UWB-enabled AP. As used herein, the client device may include a mobile computing device that supports the wireless technologies for enabling the client device to connect to the Internet or other client devices. For example, the client device may include a smartphone, a tablet, a laptop/notebook, a wearable device, or the like. Additionally, the client device may also support the UWB technology for location tracking applications and/or object detection applications.

Location tracking of the client device may be performed by forming Time Difference of Arrival (TDoA) clusters, each including a plurality of UWB-enabled APs. However, since the range of UWB is shorter than other wireless technologies (such as Wi-Fi or Bluetooth) supported by the plurality of UWB-enabled APs, it poses a challenge in forming the TDoA clusters. To that end, the TDoA technique may be replaced with a Two-Way Ranging (TWR) technique that allows the client device to directly exchange messages with individual UWB-enabled APs without forming TDoA clusters. However, the TWR technique is silent on guiding the client device in identifying and selecting additional UWB-enabled APs for subsequent ranging. Due to the lack of guidance on identifying the additional UWB-enabled APs, the client device may struggle to locate or range with these additional UWB-enabled APs, complicating the process of the location tracking of the client device. To this end, the present disclosure facilitates transmission of UWB handover recommendations to the client device.

In numerous embodiments, in order to transmit the UWB handover recommendations, the network device may be configured to acquire neighboring information of at least one neighboring UWB-enabled AP of the network device. For example, if the network device is surrounded by a first UWB-enabled AP and/or a second UWB-enabled AP, the network device may acquire neighboring information of each of the first UWB-enabled AP and/or the second UWB-enabled AP. In order to acquire the neighboring information, the network device may execute a Neighbor Discovery Protocol (NDP).

In numerous more embodiments, upon executing the NDP, the network device may receive a first Neighbor Advertisement (NA) message from the first UWB-enabled AP. The first NA message may include a connectivity identifier of the first UWB-enabled AP, a UWB identifier of the first UWB-enabled AP, UWB channel information of the first UWB-enabled AP, and/or a Wireless Local Area Network (WLAN) Received Signal Strength Indicator (RSSI) threshold of the first UWB-enabled AP. The connectivity identifier of the first UWB-enabled AP may indicate a Media Access Control (MAC) address of a Wi-Fi interface (or a Bluetooth interface) of the first UWB-enabled AP. The UWB identifier of the first UWB-enabled AP may indicate a MAC address of a UWB interface of the first UWB-enabled AP. The UWB channel information of the first UWB-enabled AP may indicate a UWB channel of the first UWB-enabled AP. The WLAN RSSI threshold of the first UWB-enabled AP may represent a specific RSSI value, above which the UWB channel of the first UWB-enabled AP is likely to be reachable. Similarly, the network device may receive, from the second UWB-enabled AP, a second NA message including a connectivity identifier of the second UWB-enabled AP, a UWB identifier of the second UWB-enabled AP, UWB channel information of the second UWB-enabled AP, and/or a WLAN RSSI threshold of the second UWB-enabled AP. Upon receiving the first NA message and/or the second NA message, the network device may compile a neighbor AP list. In an example, the neighbor AP list may be compiled to include the first NA message and/or the second NA message.

In many embodiments, upon compiling the neighbor AP list, the network device may broadcast at least one Out of band (OOB) announcement to announce its presence to the client device. For example, the OOB announcement may include a connectivity identifier of the network device, a UWB identifier of the network device, UWB channel information of the network device, and/or a WLAN RSSI threshold of the network device. In an example, the client device may receive the OOB announcement if the client device is located within a communication range of the network device. As used herein, the communication range of the network device may encompass a specific geographical area serviced by the network device. Upon receiving the OOB announcement, the client device may extract one or more identifiers of the network device from the OOB announcement and detect the network device based on extracted identifiers. Upon detecting the network device, the client device may connect to the network device.

In many further embodiments, upon connecting to the network device, the client device may measure a WLAN RSSI associated with a wireless signal of the network device. Further, the client device may determine whether the measured WLAN RSSI is greater than the WLAN RSSI threshold included in the OOB announcement. For example, the client device may compare the measured WLAN RSSI with the WLAN RSSI threshold included in the OOB announcement. If the measured WLAN RSSI is not greater than the WLAN RSSI threshold, the client device may iteratively measure the WLAN RSSI for a specific time duration or until the WLAN RSSI exceeds the WLAN RSSI threshold.

In further embodiments, if the measured WLAN RSSI is greater than the WLAN RSSI threshold included in the OOB announcement, the client device may perform a UWB ranging operation against the network device. In an example, the UWB ranging operation may include a Double-Sided Two-Way Ranging (DS-TWR) operation. In the DS-TWR operation, both the client device and the network device may execute a ranging exchange to determine their relative distances. As used herein, the ranging exchange may correspond to a ranging process in which both the client device and the network device exchange one or more UWB signals to determine their relative distances. For example, upon executing the ranging exchange, the client device may determine its distance to the network device, and the network device may determine its distance to the client device.

In still further embodiments, the UWB ranging operation may include two or more rounds of ranging exchanges. In order to execute the two or more rounds of ranging exchanges, the client device and the network device may execute the ranging exchange at a plurality of different time instances. Upon executing the two or more rounds of ranging exchanges, both the network device and the client device may obtain a plurality of distances between the client device and the network device by determining at least one distance between the client device and the network device for each time instance of the plurality of different time instances. Further, the network device may obtain a plurality of WLAN RSSIs associated with the client device for the plurality of distances by measuring a WLAN RSSI associated with the client device for each time instance of the plurality of different time instances. Furthermore, the network device may establish a plurality of correspondence relationships between the plurality of distances and the plurality of WLAN RSSIs, where each correspondence relationship may indicate a specific distance of the plurality of distances being mapped to a respective WLAN RSSI of the plurality of WLAN RSSIs.

In still yet further embodiments, the network device may determine a movement vector of the client device relative to the network device based on the two or more rounds of ranging exchanges. In an example, the determined movement vector may include a radial speed vector indicating the speed at which the client device is moving either toward or away from the network device. For example, the radial speed vector may be determined based on the plurality of distances and the plurality of different time instances.

In further additional embodiments, the network device may transmit a UWB handover recommendation to the client device based on the plurality of correspondence relationships, the determined movement vector, and/or the neighbor AP list associated with the network device. In an example, the network device may utilize a Machine Learning (ML) process to transmit the UWB handover recommendation. The ML process may include executing an ML model to obtain a selection of UWB-enabled AP from the neighbor AP list. For example, the network device may execute the ML model by inputting the plurality of correspondence relationships, the determined movement vector, and/or the neighbor AP list into the ML model. The ML model may be pre-trained to output the selection of UWB-enabled AP from the neighbor AP list by learning the plurality of correspondence relationships, the determined movement vector, and/or the neighbor AP list. The ML model may include an ensemble learning model, a Support Vector Machine (SVM), or the like. For instance, upon executing the ML model, the network device may select the first UWB-enabled AP from the neighbor AP list for a subsequent UWB ranging operation.

In additional embodiments, upon selecting the first UWB-enabled AP, the network device may generate a WLAN action frame including an indication of a proposed handover to the first UWB-enabled AP. In an example, the indication of the proposed handover may include the UWB identifier of the first UWB-enabled AP, the UWB channel information of the first UWB-enabled AP, and/or the WLAN RSSI threshold of the first UWB-enabled AP. Upon generating the WLAN action frame, the network device may transmit, as the UWB handover recommendation, the generated WLAN action frame to the client device. Upon receiving the UWB handover recommendation, the client device may attempt to perform the subsequent UWB ranging operation against the first UWB-enabled AP. For example, the client device may attempt to perform the subsequent UWB ranging operation against the first UWB-enabled AP using the UWB identifier and/or the UWB channel information included in the UWB handover recommendation. The attempt to perform the subsequent UWB ranging operation may result in a success or a failure. If the attempt results in the failure, the client device may repeatedly attempt to perform the subsequent UWB ranging operation for a predefined number of times in anticipation that a WLAN RSSI associated with the first UWB-enabled AP exceeds the WLAN RSSI threshold included in the UWB handover recommendation. If the attempt results in the failure even after attempting the subsequent UWB ranging operation for the predefined number of times, the client device may generate and transmit a WLAN action frame response to the network device. The WLAN action frame response may include an indication of the failure of the proposed handover to the first UWB-enabled AP. Conversely, if the attempt results in the success, the client device may prohibit the transmission of the WLAN action frame response.

In many additional embodiments, if the attempt results in the success, the network device may be configured to determine the success of the proposed handover of the client device to the first UWB-enabled AP based on an absence of the indication of the failure of the proposed handover. Further, the network device may update the neighbor AP list associated with the network device based on the success of the proposed handover. In an example, the neighbor AP list may be updated to indicate that the proposed handover of the client device to the first UWB-enabled AP resulted in the success.

In still additional embodiments, upon receiving the WLAN action frame response (or if the attempt results in the failure), the network device may be configured to update the neighbor AP list. For example, the neighbor AP list may be updated to remove the first UWB-enabled AP from the neighbor AP list or indicate that the proposed handover to the first UWB-enabled AP resulted in the failure. In an example, the network device may execute the ML model to update the neighbor AP list. For instance, the network device may execute the ML model by inputting the plurality of correspondence relationships, the determined movement vector, the indication of the failure, and/or the neighbor AP list into the ML model. Upon executing the ML model, the network device may update the neighbor AP list to indicate that the proposed handover to the first UWB-enabled AP resulted in the failure and further select the second UWB-enabled AP from the updated neighbor AP list.

In still yet additional embodiments, upon selecting the second UWB-enabled AP, the network device may generate an additional WLAN action frame including an indication of an additional proposed handover to the second UWB-enabled AP. In an example, the indication of the additional proposed handover may include the UWB identifier of the second UWB-enabled AP, the UWB channel information of the second UWB-enabled AP, and/or the WLAN RSSI threshold of the second UWB-enabled AP. Upon generating the additional WLAN action frame, the network device may transmit, as a new UWB handover recommendation, the generated additional WLAN action frame to the client device. Upon receiving the new UWB handover recommendation, the client device may attempt to perform the subsequent UWB ranging operation against the second UWB-enabled AP. For example, the client device may attempt to perform the subsequent UWB ranging operation against the second UWB-enabled AP using the UWB identifier and/or the UWB channel information included in the additional UWB handover recommendation. The attempt may result in the success or the failure based on the distance of the client device relative to the second UWB-enabled AP. For example, if the client device is located within a UWB range of the second UWB-enabled AP, the attempt may result in the success. Conversely, if the client device is not located within the UWB range of the second UWB-enabled AP, the attempt may result in the failure.

Advantageously, performing the UWB ranging operation against the client device may trigger the network device to transmit, to the client device, the UWB handover recommendation in order to inform the client device about at least one nearby AP that supports the UWB technology. For example, the UWB handover recommendation may include the indication of the proposed handover to the first UWB-enabled AP for the subsequent UWB ranging operation. Further, performing the UWB ranging operation against the network device may trigger the client device to receive the UWB handover recommendation and utilize the received UWB handover recommendation to perform the subsequent UWB ranging operation. Accordingly, the client device can be made aware of nearby UWB-enabled APs, ensuring that the client device does not struggle in identifying and selecting additional UWB-enabled APs for the subsequent ranging. Thus, reducing complications in the location tracking process of the client device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

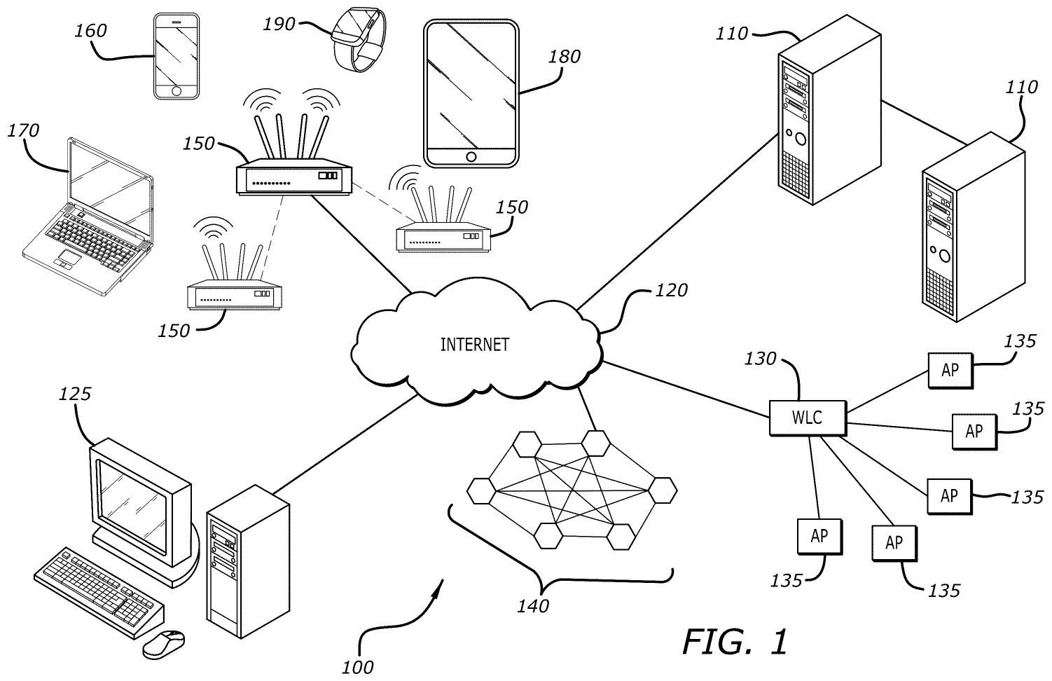

Referring to FIG. 1, a conceptual network diagram 100 of various environments in which a localization logic can operate on a plurality of network devices in accordance with various embodiments of the disclosure is shown. Those skilled in the art will recognize that the localization logic may include various hardware and/or software deployments and may be configured in a variety of ways. In many embodiments, the localization logic may be configured as a standalone device, exist as a logic in another network device, be distributed among various network devices operating in tandem, or be remotely operated as part of a cloud-based network management tool. In further embodiments, one or more servers 110 may be configured with the localization logic or may otherwise operate as the localization logic. In many further embodiments, the localization logic may operate on the one or more servers 110 connected to a communication network 120 (e.g., the “Internet”). The communication network 120 may include wired networks or wireless networks. The localization logic may be provided as a cloud-based service that may service remote networks, such as, but not limited to a deployed network 140.

However, in additional embodiments, the localization logic may be operated as a distributed logic across multiple network devices. In the embodiments depicted in FIG. 1, a plurality of Access Points (APs) 150 may operate as the localization logic in a distributed manner or may have one specific device operate as the localization logic for all of the neighboring or sibling APs 150. The APs 150 may facilitate Wi-Fi connections for various electronic devices, such as but not limited to, client devices 160-190 including at least one laptop computer 170, at least one cellular phone 160, at least one portable tablet computer 180, and at least one wearable computing device 190. In still additional embodiments, at least one client device of the client devices 160-190 may be configured with the localization logic or may otherwise operate as the localization logic.

In numerous embodiments, the localization logic may be integrated within another network device. In an example, a wireless LAN controller (WLC) 130 may be configured with the localization logic or may otherwise operate as the localization logic. The WLC 130 may control operations associated with a set of APs 135 that are connected, either wired or wirelessly, to the WLC 130. In more embodiments, a personal computer 125 may be utilized to access and/or manage various aspects of the localization logic, either remotely or within the network itself. In the embodiments depicted in FIG. 1, the personal computer 125 communicates over the communication network 120 and may access the localization logic of the servers 110, the APs 150, at least one client device of the client devices 160-190, or the WLC 130.

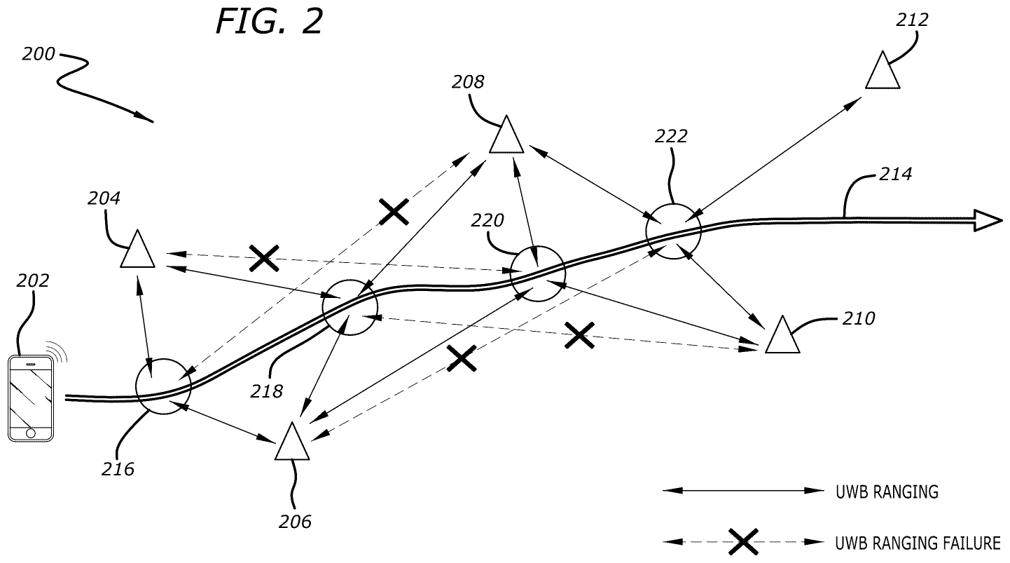

Although a specific embodiment for various environments that the localization logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the localization logic may be provided as a device or software separate from the APs 150 or the localization logic may be integrated into the APs 150. The elements depicted in FIG. 1 may also be interchangeable with other elements of FIGS. 2-14 as required to realize a particularly desired embodiment.

Referring to FIG. 2, an exemplary network environment 200 for implementing the localization logic in accordance with various embodiments of the disclosure is shown. In the embodiments shown in FIG. 2, the exemplary network environment 200 may include a client device 202 and a plurality of APs 204-212. The client device 202 may include a mobile computing device such as a smartphone, a tablet, a laptop/notebook, a wearable device, or the like. In a variety of embodiments, the client device 202 may support one or more wireless technologies (e.g., Wi-Fi, Bluetooth, or the like) to enable the client device 202 to connect to a network (e.g., the Internet) or other client devices. Additionally, the client device 202 may support an Ultra-Wideband (UWB) technology for various applications such as location tracking, object detection, or the like.

In a number of embodiments, each AP of the plurality of APs 204-212 may correspond to a network device that supports the wireless technologies for allowing one or more client devices (e.g., the client device 202) to connect to the network or other client devices. Specifically, each of the plurality of APs 204-212 may allow the client device 202 to connect to the network when the client device 202 is located within a communication range of a corresponding AP of the plurality of APs 204-212. As used herein, the communication range of a particular AP may encompass a specific geographical area serviced by the particular AP. In the embodiments shown in FIG. 2, the plurality of APs 204-212 may be positioned in such a way that the client device 202 maintains a stable connection with the network as the client device 202 traverses at least along a movement path 214.

In many embodiments, the plurality of APs 204-212 may support the UWB technology for assisting the client device 202 in determining its location within the network environment 200. Additionally, or alternatively, the plurality of APs 204-212 may be associated with a UWB device (e.g., a UWB dongle) that supports the UWB technology. In many further embodiments, while the client device 202 is moving along the movement path 214, the client device 202 may attempt to perform UWB ranging against one or more APs of the plurality of APs 204-212 to determine its location. Specifically, the client device 202 may be able to perform the UWB ranging against a particular AP of the plurality of APs 204-212 only if the client device 202 is located within a UWB range of the particular AP.

The UWB range of the plurality of APs 204-212 may be shorter than the range of the wireless technologies supported by the plurality of APs 204-212. As a result, when the client device 202 is located at a location 216, the client device 202 can connect to one or more of the APs 204, 206, and 208 using the wireless technologies but the client device 202 can perform the UWB ranging only against the APs 204 and 206. In other words, at the location 216, the client device 202 may not be able to perform the UWB ranging against the AP 208 even if the client device 202 can connect to the AP 208 using the wireless technologies. Similarly, at locations 218, 220, and 222, the client device 202 can perform the UWB ranging against the APs 204-208, the APs 206-210, and the APs 208-212, respectively. Further, at the locations 218, 220, and 222, the client device 202 may not be able to perform the UWB ranging against the APs 210, 204, and 206, respectively.

Further, when the client device 202 is at the location 216, the client device 202 may not be aware that the AP 208 supports the UWB technology unless the client device 202 either connects to the AP 208 or comes closer to the UWB range of the AP 208. As a result, the client device 202 may struggle to identify nearby APs that support the UWB technology, leading to complications in determining the location of the client device 202. To this end, in numerous embodiments, the client device 202 and at least one of the plurality of APs 204-212 are configured with the localization logic. In several embodiments, the localization logic may configure the at least one AP of the plurality of APs 204-212 to provide at least one UWB handover recommendation to the client device 202 by utilizing the wireless technologies supported by the at least one AP. In an example, the UWB handover recommendation may indicate one or more neighboring APs of the at least one AP that support the UWB technology. In several more embodiments, the localization logic may configure the client device 202 to receive the UWB handover recommendation from the at least one AP and utilize the received UWB handover recommendation for performing the UWB ranging against the neighboring APs. Accordingly, overcoming the challenges faced by the client device 202 in identifying nearby APs that support the UWB technology.

Although a specific embodiment for the network environment 200 is described above with respect to FIG. 2, any of a variety of systems and/or processes may be utilized in accordance with embodiments of the disclosure. For example, the localization logic may be embodied in a WLC. The WLC may control the plurality of APs 204-212 for providing the UWB handover recommendations to the client device 202. The elements depicted in FIG. 2 may also be interchangeable with other elements of FIG. 1 and FIGS. 3-14 as required to realize a particularly desired embodiment.

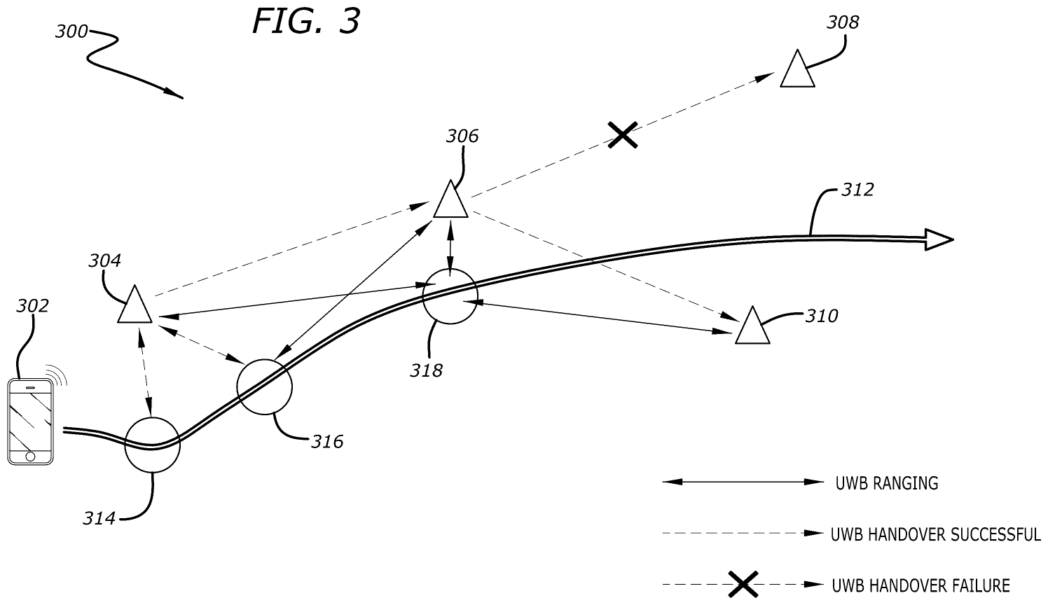

Referring to FIG. 3, an exemplary network environment 300 for providing UWB handover recommendations in accordance with various embodiments of the disclosure is shown. In the embodiments shown in FIG. 3, the network environment 300 may include a client device 302 and a plurality of APs 304-310. In various embodiments, the client device 302 and each of the plurality of APs 304-310 may support the UWB technology or may be associated with a UWB device that supports the UWB technology. Hereinafter, the plurality of APs 304-310 may be referred to as a plurality of UWB-enabled APs 304-310.

In numerous embodiments, the client device 302 and each of the plurality of UWB-enabled APs 304-310 may include a processor and a memory communicatively coupled to the processor. The processor may include suitable logic, circuitry, and interfaces that are configured to execute instructions stored in the memory. For example, the processor may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits. The memory may comprise suitable logic, circuitry, and interfaces that are configured to store a machine code and/or the instructions executable by the processor. For example, the memory may correspond to random access memory (RAM), read only memory (ROM), electrically erasable programmable read-only memory (EEPROM), hard disk drive (HDD), a solid-state drive (SSD), a CPU cache, and/or a secure digital (SD) card.

In numerous additional embodiments, the client device 302 and each of the plurality of UWB-enabled APs 304-310 may include a communication interface that is communicatively coupled to the processor and/or the memory. The communication interface may comprise suitable logic, circuitry, and interfaces that are configured to allow a device (e.g., the client device 302) to interact with other devices. For example, the communication interface may correspond to a Wi-Fi interface, a Bluetooth interface, a UWB interface, or the like. Additionally, the client device 302 and each of the plurality of UWB-enabled APs 304-310 may include a network interface controller comprising suitable logic, circuitry, and interfaces configured to provide access to a network (such as the Internet).

In the embodiments shown in FIG. 3, the plurality of UWB-enabled APs 304-310 may be positioned in such a way that the client device 302 maintains a stable connection with the network while the client device 302 traverses at least a movement path 312. In a variety of embodiments, the plurality of UWB-enabled APs 304-310 may embody the localization logic for providing the UWB handover recommendations to the client device 302. For example, the localization logic may be embodied in the processor or the memory of each of the plurality of UWB-enabled APs 304-310 or may be embodied as a standalone component within each of the plurality of UWB-enabled APs 304-310. In a number of embodiments, the client device 302 may embody the localization logic for utilizing the UWB handover recommendations provided by the plurality of UWB-enabled APs 304-310. For example, the localization logic may be embodied in the processor or the memory of the client device 302 or may be embodied as a standalone component within the client device 302.

In operation, each of the plurality of UWB-enabled APs 304-310 may execute a Neighbor Discovery Protocol (NDP) for compiling a corresponding neighbor AP list. For example, the NDP may be executed by a first UWB-enabled AP 304 of the plurality of UWB-enabled APs 304-310. Upon executing the NDP, the first UWB-enabled AP 304 may broadcast a Router Solicitation (RS) message to discover one or more neighboring APs of the first UWB-enabled AP 304. In an example, the RS message may be received by a second UWB-enabled AP 306 of the plurality of UWB-enabled APs 304-310. Upon receiving the RS message, the second UWB-enabled AP 306 may forward, to the first UWB-enabled AP 304, a Router Advertisement (RA) message indicating its presence. Upon receiving the RA message, the first UWB-enabled AP 304 may transmit, to the second UWB-enabled AP 306, a Neighbor Solicitation (NS) message requesting one or more identifiers (and/or channel information) of the second UWB-enabled AP 306. For example, the identifiers of the second UWB-enabled AP 306 may include Media Access Control (MAC) Addresses of one or more communication interfaces (e.g., the Wi-Fi interface, the Bluetooth interface, the UWB interface, or the like) of the second UWB-enabled AP 306. Upon receiving the NS message, the second UWB-enabled AP 306 may transmit, to the first UWB-enabled AP 304, a Neighbor Advertisement (NA) message indicating its identifiers. Upon receiving the NA message, the first UWB-enabled AP 304 may compile its neighbor AP list to include the identifiers of the second UWB-enabled AP 306. Similarly, the second UWB-enabled AP 306 may compile, by executing the NDP, its neighbor AP list to include one or more identifiers of the first UWB-enabled AP 304, one or more identifiers of a third UWB-enabled AP 308, and/or one or more identifiers of a fourth UWB-enabled AP 310.

In many embodiments, each of the plurality of UWB-enabled APs 304-310 may execute an Out of band (OOB) process to announce its presence to one or more client devices (e.g., the client device 302). For example, the first UWB-enabled AP 304 may execute the OOB process to announce its presence to the client device 302. Upon executing the OOB process, the first UWB-enabled AP 304 may broadcast one or more OOB announcements indicating a presence of the first UWB-enabled AP 304. In an example, the OOB announcements may include the identifiers of the first UWB-enabled AP 304. For example, the identifiers may include one or more connectivity identifiers indicating the MAC addresses of the Wi-Fi interface and/or the Bluetooth interface of the first UWB-enabled AP 304, a UWB identifier indicating the MAC address of the UWB interface (or the UWB device) of the first UWB-enabled AP 304. Additionally, the OOB announcements may include UWB channel information of the first UWB-enabled AP 304 and/or an indication of a Wireless Local Area Network (WLAN) Received Signal Strength Indicator (RSSI) threshold of the first UWB-enabled AP 304. For example, the UWB channel information may indicate a UWB channel of the first UWB-enabled AP 304. In an example, the WLAN RSSI threshold may represent a specific RSSI value, above which the UWB channel of the first UWB-enabled AP 304 is likely to be reachable. The OOB announcements may correspond to beacon frames and/or probe responses transmitted by the first UWB-enabled AP 304.

In many further embodiments, the client device 302 may receive the OOB announcements transmitted by the first UWB-enabled AP 304. For example, the client device 302 may receive the OOB announcements if the client device 302 is located within a communication range of the first UWB-enabled AP 304. Further, the client device 302 may detect the presence of the first UWB-enabled AP 304 based on the received OOB announcements. For example, in order to detect the presence of the first UWB-enabled AP 304, the client device 302 may parse the received OOB announcements to extract the identifiers of the first UWB-enabled AP 304. Upon detecting the presence of the first UWB-enabled AP 304, the client device 302 may measure a WLAN RSSI associated with a wireless signal of the first UWB-enabled AP 304. Further, the client device 302 may determine whether the measured WLAN RSSI is greater than the WLAN RSSI threshold included in the OOB announcements by comparing the measured WLAN RSSI with the WLAN RSSI threshold. If the measured WLAN RSSI is not greater than the WLAN RSSI threshold, the client device 302 may iteratively measure the WLAN RSSI for a specific time duration or until the WLAN RSSI exceeds the WLAN RSSI threshold.

For the embodiments shown in FIG. 3, the client device 302 may determine that the measured WLAN RSSI is greater than the WLAN RSSI threshold at a first location 314 along the movement path 312. Upon determining that the measured WLAN RSSI is greater than the WLAN RSSI threshold, the client device 302 may be configured to perform a UWB ranging operation against the first UWB-enabled AP 304 at the first location 314. For example, the UWB ranging operation may include a Two-Way Ranging (TWR) operation. In the TWR operation, the client device 302 may execute a ranging exchange to the first UWB-enabled AP 304 for determining a distance between the client device 302 and the first UWB-enabled AP 304. For example, upon executing the ranging exchange, the client device 302 may exchange one or more UWB signals with the first UWB-enabled AP 304 based on the UWB identifier of the first UWB-enabled AP 304 and/or the UWB channel information of the first UWB-enabled AP 304. Further, the client device 302 may determine a round-trip time associated with the UWB signals, and determine the distance between the client device 302 and the first UWB-enabled AP 304 based on the determined round-trip time. Additionally, the client device 302 may communicate the determined distance to the first UWB-enabled AP 304.

In many additional embodiments, the TWR operation may correspond to a Double-Sided Two-Way Ranging (DS-TWR) operation in which both the client device 302 and the first UWB-enabled AP 304 determine their relative distances by executing the ranging exchange. In an example, the client device 302 may determine its distance to the first UWB-enabled AP 304, and the first UWB-enabled AP 304 may determine its distance to the client device 302. Upon determining (or receiving) the distance, the first UWB-enabled AP 304 may measure a WLAN RSSI of a wireless signal associated with the client device 302. Further, the first UWB-enabled AP 304 may establish a correspondence relationship between the measured WLAN RSSI associated with the client device 302 and the determined distance. In an example, in order to establish the correspondence relationship, the first UWB-enabled AP 304 may map the determined distance to the measured WLAN RSSI associated with the client device 302.

In further embodiments, the first UWB-enabled AP 304 (and/or the client device 302) may be configured to determine a plurality of distances between the client device 302 and the first UWB-enabled AP 304. In order to determine the plurality of distances, the first UWB-enabled AP 304 may execute two or more rounds of ranging exchanges. For example, in order to determine the plurality of distances, the first UWB-enabled AP 304 may execute the ranging exchange for a plurality of different time instances. Further, the first UWB-enabled AP 304 may be configured to measure the WLAN RSSI associated with the client device 302 for each time instance of the plurality of different time instances to obtain a plurality of WLAN RSSIs associated with the client device 302. Furthermore, the first UWB-enabled AP 304 may be configured to establish a plurality of correspondence relationships between the plurality of distances and the plurality of WLAN RSSIs. For example, each correspondence relationship of the plurality of correspondence relationships may indicate that a specific distance of the plurality of distances is mapped to a respective WLAN RSSI of the plurality of WLAN RSSIs.

In further additional embodiments, the first UWB-enabled AP 304 may be configured to determine a movement vector of the client device 302 relative to the first UWB-enabled AP 304 based on the two or more rounds of ranging exchanges. As used herein, the movement vector may correspond to a radial speed vector of the client device 302 relative to the first UWB-enabled AP 304. The radial speed vector may indicate the speed at which the client device 302 is moving either toward or away from the first UWB-enabled AP 304. For example, the radial speed vector may be determined based on the plurality of distances and the plurality of different time instances.

In still further embodiments, the first UWB-enabled AP 304 may be configured to provide a UWB handover recommendation to the client device 302 based on the plurality of correspondence relationships, the determined movement vector, and/or the neighbor AP list associated with the first UWB-enabled AP 304. In an example, the first UWB-enabled AP 304 may utilize a Machine Learning (ML) process to provide the UWB handover recommendation. The ML process may include executing an ML model for obtaining a selection of UWB-enabled AP. For example, the first UWB-enabled AP 304 may execute the ML model by inputting the plurality of correspondence relationships, the determined movement vector, and/or the neighbor AP list into the ML model. For instance, the ML model may be pre-trained to output the selection of UWB-enabled AP from the neighbor AP list by learning the plurality of correspondence relationships, the determined movement vector, and/or the neighbor AP list. The ML model may include an ensemble learning model, a Support Vector Machine (SVM), or the like.

For the embodiments shown in FIG. 3, upon executing the ML model, the first UWB-enabled AP 304 may select the second UWB-enabled AP 306 from the neighbor AP list. Further, the first UWB-enabled AP 304 may transmit, to the client device 302, the UWB handover recommendation based on the selected second UWB-enabled AP 306. For example, the UWB handover recommendation may be transmitted via a WLAN action frame. In an example, the UWB handover recommendation may include handover information indicating a proposed handover to the second UWB-enabled AP 306 for a subsequent UWB ranging operation. For example, the handover information may include a UWB identifier of the second UWB-enabled AP 306, UWB channel information of the second UWB-enabled AP 306, and/or an indication of a WLAN RSSI threshold of the second UWB-enabled AP 306.

In still yet further embodiments, upon receiving the UWB handover recommendation, the client device 302 may attempt to perform the subsequent UWB ranging operation against the second UWB-enabled AP 306. In an example, the client device 302 may attempt to perform the subsequent UWB ranging operation against the second UWB-enabled AP 306 using the UWB identifier and/or the UWB channel information included in the UWB handover recommendation. The attempt to perform the subsequent UWB ranging operation may result in a success or a failure. If the attempt results in the failure, the client device 302 may repeatedly attempt to perform the subsequent UWB ranging operation for a predefined number of times in anticipation that a WLAN RSSI associated with the second UWB-enabled AP 306 exceeds the WLAN RSSI threshold included in the UWB handover recommendation.

For the embodiments shown in FIG. 3, the client device 302 may determine that the WLAN RSSI associated with the second UWB-enabled AP 306 exceeds the WLAN RSSI threshold at a second location 316 along the movement path 312. In more embodiments, upon determining that the WLAN RSSI associated with the second UWB-enabled AP 306 exceeds the WLAN RSSI threshold, the client device 302 may perform the subsequent UWB ranging operation against the second UWB-enabled AP 306 at the second location 316. For example, the subsequent UWB ranging operation may correspond to the DS-TWR operation including the two or more rounds of ranging exchanges. Upon performing the subsequent UWB ranging operation, both the client device 302 and the second UWB-enabled AP 306 may determine a plurality of distances between the client device 302 and the second UWB-enabled AP 306. Further, the second UWB-enabled AP 306 may obtain a plurality of WLAN RSSIs associated with the client device 302 for the plurality of distances. Furthermore, the second UWB-enabled AP 306 may establish a plurality of correspondence relationships between the plurality of distances and the plurality of WLAN RSSIs. Additionally, the second UWB-enabled AP 306 may determine the movement vector of the client device 302 based on the plurality of distances.

In still more embodiments, the second UWB-enabled AP 306 may transmit a subsequent UWB handover recommendation to the client device 302 based on the plurality of correspondence relationships, the determined movement vector, and/or the neighbor AP list associated with the second UWB-enabled AP 306. For example, the subsequent UWB handover recommendation may include subsequent handover information indicating a subsequent proposed handover to the third UWB-enabled AP 308 for a next UWB ranging operation. In an example, the subsequent handover information may include a UWB identifier of the third UWB-enabled AP 308, UWB channel information of the third UWB-enabled AP 308, and/or an indication of a WLAN RSSI threshold of the third UWB-enabled AP 308.

In yet more embodiments, upon receiving the subsequent UWB handover recommendation, the client device 302 may attempt to perform the next UWB ranging operation against the third UWB-enabled AP 308. For example, the client device 302 may attempt to perform the next UWB ranging operation against the third UWB-enabled AP 308 using the UWB identifier and/or the UWB channel information included in the subsequent UWB handover recommendation. If the attempt results in the failure, the client device 302 may repeatedly attempt to perform the next UWB ranging operation for the predefined number of times in anticipation that a WLAN RSSI associated with the third UWB-enabled AP 308 exceeds the WLAN RSSI threshold included in the subsequent UWB handover recommendation. For example, if the client device 302 determines that the WLAN RSSI does not exceed the WLAN RSSI threshold even after attempting the next UWB ranging operation for the predefined number of times, the client device 302 may transmit, to the second UWB-enabled AP 306, an indication of the failure of the subsequent proposed handover to the third UWB-enabled AP 308. For example, the indication of the failure may be transmitted via a WLAN action frame response.

In still yet more embodiments, upon receiving the indication of the failure, the second UWB-enabled AP 306 may update the neighbor AP list associated with the second UWB-enabled AP 306. For example, the neighbor AP list may be updated to remove the third UWB-enabled AP 308 from the neighbor AP list or indicate that the subsequent proposed handover to the third UWB-enabled AP 308 resulted in the failure. In an example, the second UWB-enabled AP 306 may execute the ML model to update the neighbor AP list. For instance, the second UWB-enabled AP 306 may execute the ML model by inputting the plurality of correspondence relationships, the determined movement vector, the indication of the failure, and/or the neighbor AP list into the ML model. The ML model may be pre-trained to update the neighbor AP list for an input of the indication of the failure and the neighbor AP list, and to output a new selection of UWB-enabled AP from the updated neighbor AP list by learning the plurality of correspondence relationships and the determined movement vector.

For the embodiments shown in FIG. 3, upon executing the ML model, the second UWB-enabled AP 306 may select the fourth UWB-enabled AP 310 from the updated neighbor AP list. Further, the second UWB-enabled AP 306 may transmit a new subsequent UWB handover recommendation to the client device 302 based on the selected fourth UWB-enabled AP 310. For example, the new subsequent UWB handover recommendation may include additional handover information indicating an additional proposed handover to the fourth UWB-enabled AP 310 for the next UWB ranging operation. In an example, the additional handover information may include a UWB identifier of the fourth UWB-enabled AP 310, UWB channel information of the fourth UWB-enabled AP 310, and/or an indication of a WLAN RSSI threshold of the fourth UWB-enabled AP 310.

In additional embodiments, upon receiving the new subsequent UWB handover recommendation, the client device 302 may attempt to perform the next UWB ranging operation against the fourth UWB-enabled AP 310. If the attempt results in the failure, the client device 302 may repeatedly attempt to perform the next UWB ranging operation for the predefined number of times in anticipation that a WLAN RSSI associated with the fourth UWB-enabled AP 310 exceeds the WLAN RSSI threshold included in the new subsequent UWB handover recommendation. For the embodiments shown in FIG. 3, the client device 302 may determine that the WLAN RSSI associated with the fourth UWB-enabled AP 310 exceeds the WLAN RSSI threshold at a third location 318.

In still additional embodiments, upon determining that the WLAN RSSI associated with the fourth UWB-enabled AP 310 exceeds the WLAN RSSI threshold, the client device 302 may perform the next UWB ranging operation against the fourth UWB-enabled AP 310 at the third location 318. For example, the next UWB ranging operation may correspond to the DS-TWR operation. In still yet additional embodiments, the client device 302 may determine its location by performing the UWB ranging operation, the subsequent UWB ranging operation, and the next UWB ranging operation against the first UWB-enabled AP 304, the second UWB-enabled AP 306, and the fourth UWB-enabled AP 310, respectively.

In several embodiments, the second UWB-enabled AP 306 may be configured to determine the success of the additional proposed handover to the fourth UWB-enabled AP 310. In an example, the second UWB-enabled AP 306 may determine the success of the additional proposed handover if the second UWB-enabled AP 306 does not receive an indication of the failure of the additional proposed handover. In several more embodiments, upon determining the success of the additional proposed handover, the second UWB-enabled AP 306 may update the neighbor AP list associated with the second UWB-enabled AP 306. In an example, the neighbor AP list may be updated to indicate that the additional proposed handover to the fourth UWB-enabled AP 310 resulted in the success.

In this way, the plurality of UWB-enabled APs 304-310 may be configured to provide the UWB handover recommendations to the client device 302 in order to inform the client device 302 about its nearby APs that support the UWB technology. Further, the client device 302 may be configured to utilize the UWB handover recommendations received from the plurality of UWB-enabled APs 304-310 in order to determine its location. Accordingly, the client device 302 may not struggle to identify the nearby UWB-enabled APs for determining its location.

Although the network environment 300 including four UWB-enabled APs 304-310 is shown, the scope of the present disclosure is not limited to it. For example, the network environment 300 may include at least two UWB-enabled APs. In some more embodiments, the network environment 300 may also include one or more non-UWB-enabled APs that do not support the UWB technology. In these embodiments, the UWB-enabled APs may not consider the non-UWB-enabled APs as candidates for generating the UWB handover recommendations.

Although a specific embodiment of the network environment 300 for carrying out the various steps, processes, methods, and operations described herein is discussed with respect to FIG. 3, any of a variety of systems and/or processes may be utilized in accordance with embodiments of the disclosure. For example, the network environment 300 may include multiple client devices (similar to the client device 302), where each client device may determine its location by utilizing the UWB handover recommendations provided by the plurality of UWB-enabled APs 304-310. The elements depicted in FIG. 3 may also be interchangeable with other elements of FIGS. 1-2 and FIGS. 4-14 as required to realize a particularly desired embodiment.

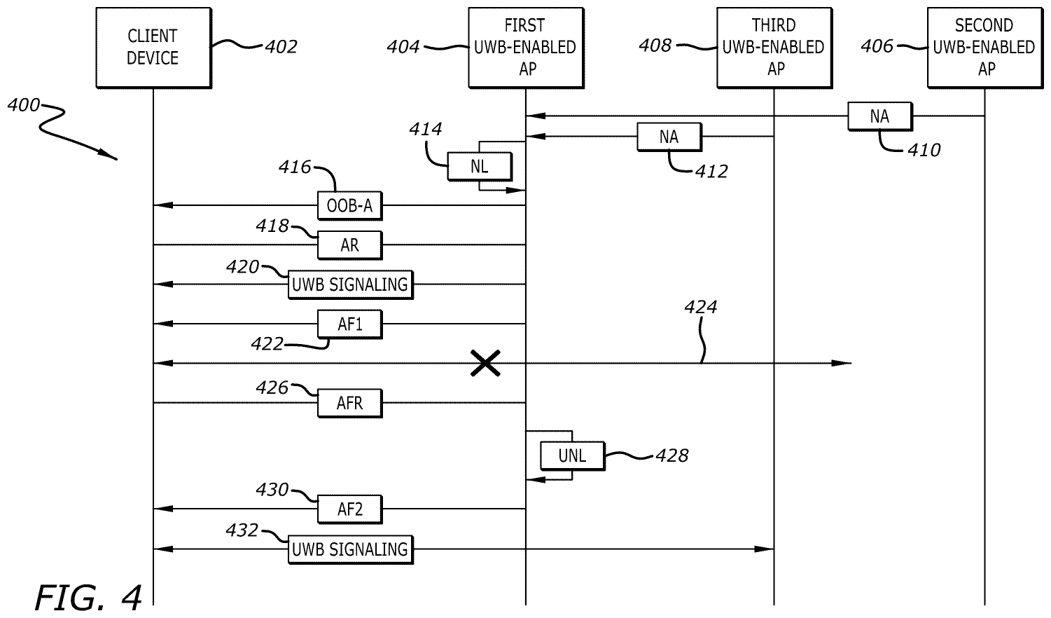

Referring to FIG. 4, a conceptual process flow diagram 400 for performing multiple UWB ranging operations in accordance with various embodiments of the disclosure is shown. In the embodiments shown in FIG. 4, the conceptual process flow diagram 400 may include a client device 402 and a plurality of UWB-enabled APs 404-408 including a first UWB-enabled AP 404, a second UWB-enabled AP 406, and a third UWB-enabled AP 408. In various embodiments, the client device 402 and each of the plurality of UWB-enabled APs 404-408 may support one or more of Wi-Fi, Bluetooth, or the UWB technologies.

In numerous embodiments, each UWB-enabled AP of the plurality of UWB-enabled APs 404-408 may execute an NDP for exchanging an NA message with each other UWB-enabled AP. For example, the first UWB-enabled AP 404 may receive a first NA message 410 from the second UWB-enabled AP 406. The first NA message 410 may include one or more connectivity identifiers of the second UWB-enabled AP 406, a UWB identifier of the second UWB-enabled AP 406, UBW channel information of the second UWB-enabled AP 406, and/or a WLAN RSSI threshold of the second UWB-enabled AP 406. Further, the first UWB-enabled AP 404 may receive a second NA message 412 from the third UWB-enabled AP 408. The second NA message 412 may include one or more connectivity identifiers of the third UWB-enabled AP 408, a UWB identifier of the third UWB-enabled AP 408, UBW channel information of the third UWB-enabled AP 408, and/or a WLAN RSSI threshold of the third UWB-enabled AP 408. Additionally, the first UWB-enabled AP 404 may also transmit the NA message to each of the second UWB-enabled AP 406 and the third UWB-enabled AP 408.

In numerous more embodiments, each UWB-enabled AP of the plurality of UWB-enabled APs 404-408 may create its neighbor AP list. For example, the first UWB-enabled AP 404 may create its neighbor AP list 414 (denoted as “NL” in FIG. 4). The neighbor AP list 414 may be created based on the first NA message 410 and the second NA message 412. The neighbor AP list may include information (e.g., connectivity identifiers, UWB identifiers, UBW channel information, or the like) about the second UWB-enabled AP 406 and the third UWB-enabled AP 408.

In many embodiments, each UWB-enabled AP of the plurality of UWB-enabled APs 404-408 may broadcast an OOB announcement to announce its presence to the client device 402. For example, the first UWB-enabled AP 404 may broadcast an OOB announcement 416 (denoted as “OOB-A” in FIG. 4) to announce its presence to the client device 402. The OOB announcement 416 may include one or more connectivity identifiers of the first UWB-enabled AP 404, a UWB identifier of the first UWB-enabled AP 404, UBW channel information of the first UWB-enabled AP 404, and/or a WLAN RSSI threshold of the first UWB-enabled AP 404. In a variety of embodiments, the client device 402 may receive the OOB announcement 416 if the client device 402 is located within a communication range of the first UWB-enabled AP 404. As used herein, the communication range of the first UWB-enabled AP 404 may indicate a specific geographical area serviced by the first UWB-enabled AP 404.

In many further embodiments, upon receiving the OOB announcement 416, the client device 402 may transmit, to the first UWB-enabled AP 404, an association request 418 (denoted as “AR” in FIG. 4). In an example, the association request 418 may indicate that the client device 402 wants to join a network associated with the first UWB-enabled AP 404. Upon receiving the association request 418, the first UWB-enabled AP 404 may allow the client device 402 to join the network.

In further embodiments, upon allowing the client device 402 to join the network, the first UWB-enabled AP 404 may attempt to perform a UWB ranging operation 420 (denoted as “UWB signaling” in FIG. 4) against the client device 402. For example, the attempt may result in a success if the client device 402 is located within a UWB range of the first UWB-enabled AP 404. Conversely, if the client device 402 is not located within the UWB range of the first UWB-enabled AP 404, the attempt may result in a failure. If the attempt results in the failure, the first UWB-enabled AP 404 may repeatedly attempt to perform the UWB ranging operation 420 (denoted as “UWB signaling” in FIG. 4) for a predefined number of times in anticipation that the attempt results in the success.

In still further embodiments, the UWB ranging operation 420 may include a TWR operation having two or more rounds of ranging exchanges. In order to execute the two or more rounds of ranging exchanges, the first UWB-enabled AP 404 may execute a ranging exchange at a plurality of different time instances. Upon executing the ranging exchange at a specific time instance of the plurality of different time instances, the first UWB-enabled AP 404 may exchange one or more UWB signals with the client device 402, and determine a distance between the client device 402 and the first UWB-enabled AP 404 based on a round-trip time associated with the one or more UWB signals. Upon executing the two or more rounds of ranging exchanges, the first UWB-enabled AP 404 may determine a plurality of distances between the client device 402 and the first UWB-enabled AP 404.

In still yet further embodiments, the first UWB-enabled AP 404 may obtain a plurality of WLAN RSSIs associated with the client device 402 for the plurality of distances. In an example, the plurality of WLAN RSSIs may be obtained by measuring a WLAN RSSI associated with the client device 402 at each time instance of the plurality of different time instances. Further, the first UWB-enabled AP 404 may establish a plurality of correspondence relationships between the plurality of distances and the plurality of WLAN RSSIs. For example, each correspondence relationship of the plurality of correspondence relationships may indicate a specific distance of the plurality of distances is mapped to a respective WLAN RSSI of the plurality of WLAN RSSIs.

In further additional embodiments, the first UWB-enabled AP 404 may determine a movement vector of the client device 402 relative to the first UWB-enabled AP 404 based on the two or more rounds of ranging exchanges. In an example, the movement vector may include a radial speed vector indicating the speed at which the client device 402 is moving either toward or away from the first UWB-enabled AP 404. For example, the radial speed vector may be determined based on the plurality of distances and the plurality of different time instances.

In additional embodiments, the first UWB-enabled AP 404 may transmit a WLAN action frame 422 (denoted as “AF1” in FIG. 4) to the client device 402 based on the plurality of correspondence relationships, the determined movement vector, and/or the neighbor AP list associated with the first UWB-enabled AP 404. In order to transmit the WLAN action frame 422, the first UWB-enabled AP 404 may execute an ML model based on the plurality of correspondence relationships, the determined movement vector, and/or the neighbor AP list. For example, the ML model may include an ensemble learning model, an SVM, or the like. In a number of embodiments, the ML model may be pre-trained to output a selection of UWB-enabled AP from the neighbor AP list by learning the plurality of correspondence relationships, the determined movement vector, and/or the neighbor AP list. In an example, upon executing the ML model, the first UWB-enabled AP 404 may select the second UWB-enabled AP 406.

In still additional embodiments, upon selecting the second UWB-enabled AP 406, the first UWB-enabled AP 404 may generate the WLAN action frame 422 including an indication of a proposed handover to the second UWB-enabled AP 406. In an example, the indication of the proposed handover may include the UWB identifier of the second UWB-enabled AP 406, the UWB channel information of the second UWB-enabled AP 406, and/or the WLAN RSSI threshold of the second UWB-enabled AP 406. Further, upon generating the WLAN action frame 422, the first UWB-enabled AP 404 may transmit the WLAN action frame 422 to the client device 402.

In still yet additional embodiments, upon receiving the WLAN action frame 422, the client device 402 may attempt to perform a subsequent UWB ranging operation 424 against the second UWB-enabled AP 406. For example, the attempt may result in a success, if the client device 402 is located within a UWB range of the second UWB-enabled AP 406. Conversely, if the client device 402 is not located within the UWB range of the second UWB-enabled AP 406, the attempt may result in a failure. If the attempt results in the failure, the client device 402 may repeatedly attempt to perform the subsequent UWB ranging operation 424 for a predefined number of times in anticipation that the attempt results in the success.

In many additional embodiments, if the attempt results in the failure even after attempting the subsequent UWB ranging operation 424 for the predefined number of times, the client device 402 may transmit a WLAN action frame response 426 (denoted as “AFR” in FIG. 4) to the first UWB-enabled AP 404. In an example, the WLAN action frame response 426 may include an indication of the failure of the proposed handover to the second UWB-enabled AP 406. In numerous additional embodiments, upon receiving the WLAN action frame response 426, the first UWB-enabled AP 404 may update the neighbor AP list associated with the first UWB-enabled AP 404. In an example, the first UWB-enabled AP 404 may execute the ML model based on the indication of the failure of the proposed handover, the plurality of correspondence relationships, the determined movement vector, and/or the neighbor AP list. Upon executing the ML model, the first UWB-enabled AP 404 may obtain an updated neighbor AP list 428 (denoted as “UNL” in FIG. 4). In an example, the updated neighbor AP list 428 may be an updated version of the neighbor AP list 414. For example, the updated neighbor AP list 428 may indicate that the proposed handover to the second UWB-enabled AP 406 resulted in the failure. Further, upon executing the ML model, the first UWB-enabled AP 404 may select the third UWB-enabled AP 408 from the updated neighbor AP list 428.

In several embodiments, upon selecting the third UWB-enabled AP 408, the first UWB-enabled AP 404 may generate and transmit a WLAN action frame 430 (denoted as “AF2” in FIG. 4) to the client device 402. For example, the WLAN action frame 430 may include an indication of an additional proposed handover to the third UWB-enabled AP 408. In an example, the indication of the additional proposed handover may include the UWB identifier of the third UWB-enabled AP 408, the UWB channel information of the third UWB-enabled AP 408, and/or the WLAN RSSI threshold of the third UWB-enabled AP 408.

In several more embodiments, upon receiving the WLAN action frame 430, the client device 402 may attempt to perform a subsequent UWB ranging operation 432 (denoted as “UWB signaling” in FIG. 4) against the third UWB-enabled AP 408. In an example, the subsequent UWB ranging operation 432 may be performed based on the UWB identifier of the third UWB-enabled AP 408 and the UWB channel information of the third UWB-enabled AP 408. For example, the attempt may result in a success if the client device 402 is located within a UWB range of the third UWB-enabled AP 408. Conversely, if the client device 402 is not located within the UWB range of the third UWB-enabled AP 408, the attempt may result in a failure. For the embodiments shown in FIG. 4, the client device 402 may perform the subsequent UWB ranging operation 432 against the third UWB-enabled AP 408. In an example, the subsequent UWB ranging operation 432 may be the TWR operation for determining a distance between the client device 402 and the third UWB-enabled AP 408.

Although a specific embodiment of the conceptual process flow diagram 400 for carrying out the various steps, processes, methods, and operations described herein is discussed with respect to FIG. 4, any of a variety of systems and/or processes may be utilized in accordance with embodiments of the disclosure. For example, upon performing the subsequent UWB ranging operation 432, the client device 402 may receive, from the third UWB-enabled AP 408, a subsequent WLAN action frame including an indication of at least one subsequent proposed handover to at least one neighboring AP of the third UWB-enabled AP 408. The elements depicted in FIG. 4 may also be interchangeable with other elements of FIGS. 1-3 and 5-14 as required to realize a particularly desired embodiment.

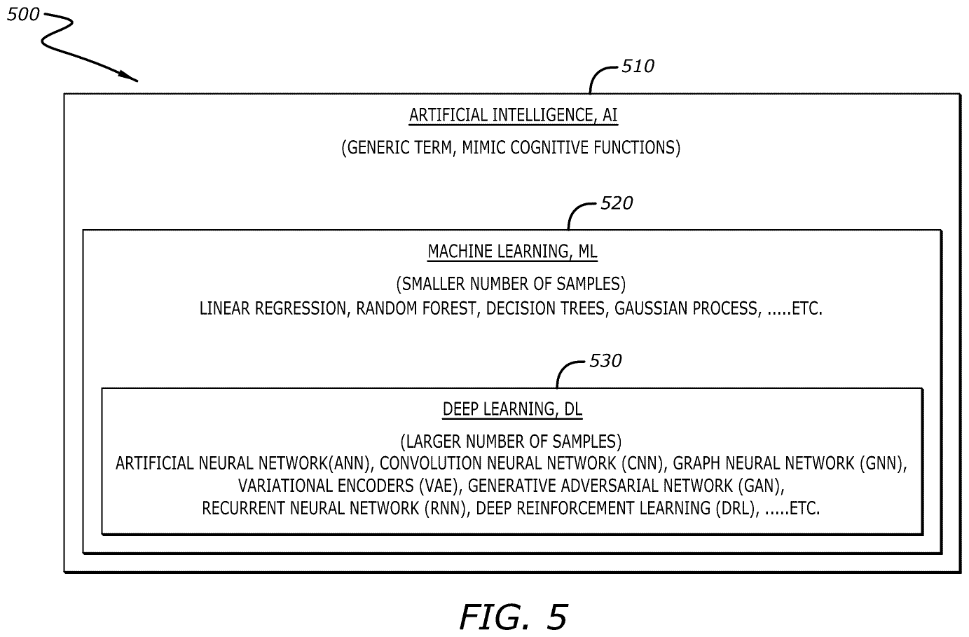

Referring to FIG. 5, a diagram 500 depicting various subsets of artificial intelligence in accordance with various embodiments of the disclosure is shown. Artificial intelligence (AI) 510 is typically understood in the art to be the development of machines and algorithms that mimic human intelligence, for example, by optimizing actions to achieve certain goals. At its core, AI 510 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 510 can be considered a generic term because it encompasses a wide range of subfields and techniques, from simple rule-based systems to advanced machine learning and deep learning models. These AI techniques are used to simulate various aspects of human cognition. For example, machine learning (ML) 520 allows computers to learn from data patterns without explicit programming for each task, while natural language processing (NLP) enables machines to understand and generate human language. Deep learning (DL) 530, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As the AI 510 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 520 is a subset of AI 510 that focuses on the development of algorithms and statistical models that enable computers to learn and make decisions from data without explicit programming. In traditional programming, a computer is given a fixed set of rules to follow, but ML 520 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to select a UWB-enabled AP for proposing a UWB handover to a client device that is in a network environment having a plurality of UWB-enabled APs.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 520. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical client device data, historical UWB-enabled APs data, developer inputs, quality assurance/testing feedback, among other sources.

However, traditional ML methods rely heavily on feature engineering, wherein human experts manually identify the most relevant features or patterns within the data. For example, when using ML 520 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

DL 530 is a specialized subset of ML 520 that employs multi-layered artificial neural networks to automatically learn complex patterns and representations from large, often unstructured datasets. Inspired by the way the human brain processes information, DL 530 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 530 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is required for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML neural network designed to work well with any kind of input data, for example, the input data may include distance information between at least one client device and at least one UWB-enabled AP, WLAN RSSI information associated with the client device, and/or correspondence relationship information between the distance information and the WLAN RSSI information. In an example, the input data may be generated within a network environment that includes the client device and the plurality of UWB-enabled APs. As those skilled in the art will recognize, CNNs typically use specialized layers known as convolutional layers, which apply filters (also known as kernels) to the input data. These filters slide over the input data, detecting patterns, which are then passed to the next layer for further processing. The advantage of CNNs is their ability to automatically learn and extract relevant features from raw data without the need for manual feature engineering. After several layers of convolutions, the CNN can output a prediction, such as a selection of UWB-enabled AP from the plurality of UWB-enabled APs for proposing the UWB handover to the client device.

In many embodiments, the CNNs may encompass Graph Neural Networks (GNNs) that are designed to work particularly well with graph-based input data. In these embodiments, the input data may be converted into the graph-based input data. In order to convert the input data into the graph-based input data, the input data may be represented as a graph, where nodes represent entities (e.g., the distance information and/or the WLAN RSSI information) and edges represent relationships between the entities.

In GNNs, information is passed between nodes through edges in a process called message passing. This allows the network to capture dependencies and relationships within the graph structure. The key feature of GNNs is their ability to aggregate information from neighboring nodes, which is required in predicting properties that depend on the current/local structure, such as a variation in the WLAN RSSI information relative to the distance information.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to select the UWB-enabled AP from the plurality of UWB-enabled APs or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare the outputted UWB-enabled AP selection to a realistic UWB-enabled AP selection.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from the input data.

In the network environment including the client device and the plurality of UWB-enabled APs, DRL can be used in scenarios where an optimal decision needs to be made, such as selecting an optimal UWB-enabled AP from a neighbor AP list including one or more UWB-enabled APs of the plurality of UWB-enabled APs or updating the neighbor AP list based on the desired or current relations between the client device and an associated UWB-enabled AP. The combination of RL and DL can allow for learning from raw data, making it a powerful tool for dynamic and real-time decision-making within the network environment.

Although a specific embodiment for a diagram 500 depicting various subsets of artificial intelligence suitable for carrying out the various steps, processes, methods, and operations described herein is discussed with respect to FIG. 5, any of a variety of systems and/or processes may be utilized in accordance with embodiments of the disclosure. For example, other subset may be present and available for use within AI 510. Those skilled in the art will recognize that the diagram 500 presented in FIG. 5 is simplified for illustration purposes and various methods and techniques may interact with other areas (ML 520 with DL 530, etc.). The elements depicted in FIG. 5 may also be interchangeable with other elements of FIGS. 1-4 and 6-14 as required to realize a particularly desired embodiment.

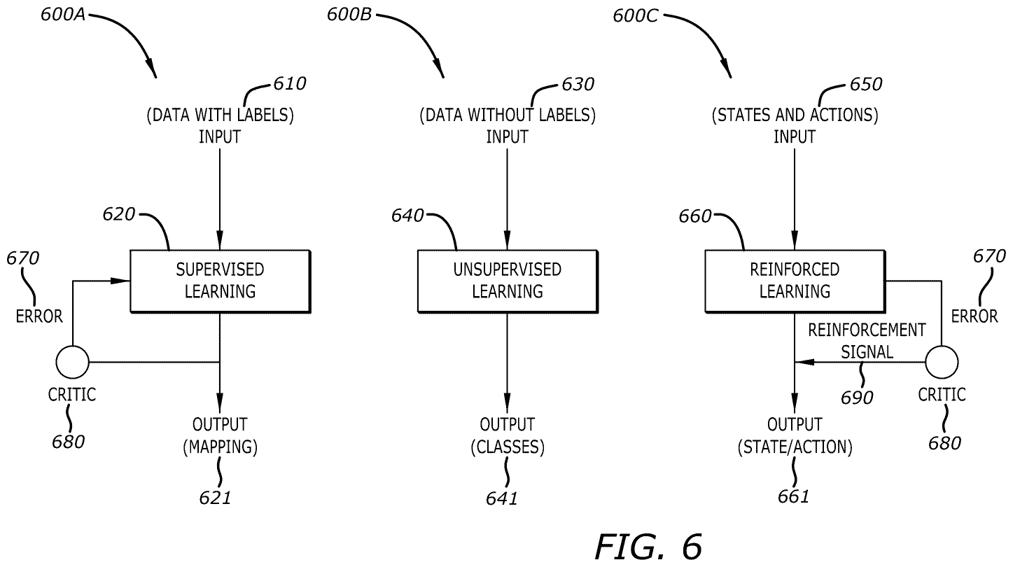

Referring to FIG. 6, different methods of machine-based learning in accordance with various embodiments of the disclosure are shown. In many embodiments, an ML model is defined as a mathematical representation of the output of the training process. An ML model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 6, a supervised learning system 600A is shown. The supervised learning system 600A can be configured with a supervised learning model 620 that accepts input data 610 and generates an output 621. However, the output data is often reviewed by a critic 680 that can determine one or more errors 670 that are fed back into the supervised learning model 620 for use in updating.

Supervised learning systems 600A are often considered the simplest machine learning model to understand in which input data (such as training data) has a known label or result as an output. So, the supervised learning model 620 can be understood to work on the principle of input-output pairs. As such, a function can be trained using a training data set, which is then applied to unknown data and makes some predictive performance. Supervised learning is task-based and mostly tested on labeled data sets.

Supervised learning systems 600A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve). Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to a UWB-enabled AP selection and/or a neighbor AP list update. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are the another type of supervised learning, which can be used to generate conclusions from observed values in one or more categorical forms. For example, a classification model can identify if an email is spam or not; whether a UWB-enabled AP can be selected as the optimal UWB-enabled AP for proposing a handover to a client device, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is an SVM which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on distance information between the client device and at least one UWB-enabled AP, WLAN RSSI information associated with the client device, correspondence relationship information between the distance information and the WLAN RSSI information, etc.

Again, in the embodiment depicted in FIG. 6, an unsupervised learning system 600B is shown. The unsupervised learning system 600B can be configured with an unsupervised learning model 640 that accepts input data 630 and generates an output 641. Unlike other model types, there are no critics or error signals to process. Unsupervised learning models 640 can implement the learning process opposite to supervised learning, which means it enables the model to learn from an unlabeled training dataset. Based on the unlabeled dataset, the unsupervised learning model 640 can predict the output. Using an unsupervised learning system 600B, the unsupervised learning model 640 can learn hidden patterns from the dataset by itself without any supervision. In various embodiments, unsupervised learning models 640 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to perform a UWB-enabled AP selection from a plurality of UWB-enabled APs for proposing the handover to the client device. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 6, a reinforcement learning system 600C is shown. The reinforcement learning system 600C can be configured with a reinforcement learning model 660 that accepts input data 650 and generates an output 661. In reinforcement learning, the reinforcement learning model 660 learns actions for a given set of states that lead to a goal state. In the embodiment depicted in FIG. 6, a critic 680 can receive or otherwise notice an error 670 within the reinforcement learning model 660 actions, and transmit a reinforcement signal 690 to adjust the outcome/output such that the “reward” or “punishment” is adjusted to better model the future behaviors or processing of the reinforcement learning model 660.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 6, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 6 may also be interchangeable with other elements of FIGS. 1-5 and 7-14 as required to realize a particularly desired embodiment.

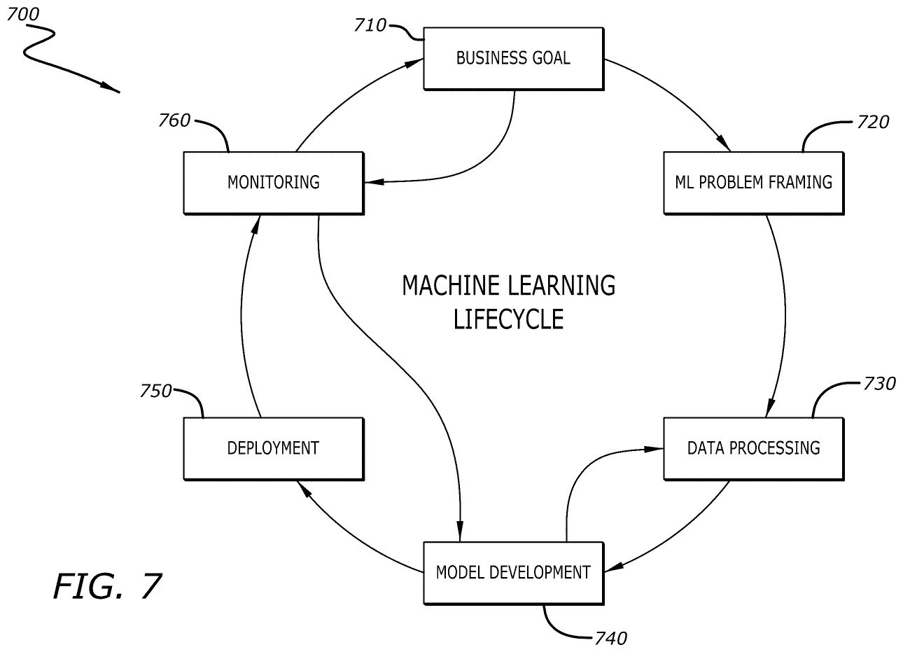

Referring to FIG. 7, a machine learning lifecycle 700 in accordance with various embodiments of the disclosure is shown. During the development of machine learning systems, the embodiment depicted in FIG. 7 can provide a framework for how to structure the design and maintenance of these systems. This machine learning lifecycle 700 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 700 emphasizes that developing a machine learning model is not a one-time effort but an iterative process requiring ongoing monitoring and adjustment. The feedback loop inherent in the machine learning lifecycle 700 allows for continual refinement and optimization of models to maintain their accuracy and relevance.

In many embodiments, a first stage of the machine learning lifecycle 700 is identifying the business goal 710, which sets the overall direction and purpose of the ML project. This can involve understanding the specific problems or opportunities within the business or project that machine learning can address. A clear business goal 710 ensures that the project remains focused on delivering tangible value, whether it is improving a UWB-enabled AP selection process, a neighbor AP list update process, or the like. Without a well-defined goal, it can be challenging to align the subsequent stages of the ML lifecycle 700, as the choice of model, data processing methods, and performance metrics can all depend on what the business aims to achieve.

Establishing a proper business goal 710 can also involve engaging with key stakeholders and developers to gather requirements and set success criteria. It can provide a roadmap that outlines what success looks like and helps in framing the ML problem. For example, if the goal is to select the optimal UWB-enable AP for proposing a handover to a client device, the project might focus on building a predictive model that identifies potential bottlenecks, allowing the selection engine to intervene proactively. Clearly defined goals not only help guide the project but also provide benchmarks for evaluating the effectiveness of the deployed model once it enters production.

Once the business goal 710 is established, various embodiments take a next step involving ML problem framing 720, wherein the goal is translated into a specific machine learning task. This can involve selecting the appropriate type of ML problem, such as classification, regression, clustering, or recommendation, and defining the target variables or outputs. For example, if the goal is to identify the bottlenecks, the problem can be framed as a binary classification task where the model predicts whether a certain number of UWB-enabled APs will cause the selection engine to slow down. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 730 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 730 can require or at least benefit from careful planning and iterative refinement. Once the data is processed, it is typically split into training, validation, and test sets to develop and evaluate the model, ensuring that it generalizes well to new, unseen data.

Model development 740 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 740, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 730.

In further embodiments, deployment 750 is the stage where the developed model is integrated into the production environment to perform its intended tasks. This phase may involve setting up the necessary infrastructure, such as APIs or cloud-based services, to allow the model(s) to process live data and generate predictions. Deployment 750 can transform the model from a research tool into a functional component of a business process or product, providing real-time insights, automations, or decisions.

Proper deployment 750 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 710.

In more embodiments, monitoring 760 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 760, teams can identify when the model's performance drops and requires retraining or adjustments to align with the evolving data.

Monitoring 760 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 730 and model development 740, to refine the model(s) as needed. This iterative process allows the machine learning system to adapt and maintain its alignment with the original business goal 710 over time.

Although a specific embodiment for a machine learning lifecycle 700 suitable for carrying out the various steps, processes, methods, and operations described herein is discussed with respect to FIG. 7, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 7 may also be interchangeable with other elements of FIGS. 1-6 and 8-14 as required to realize a particularly desired embodiment.

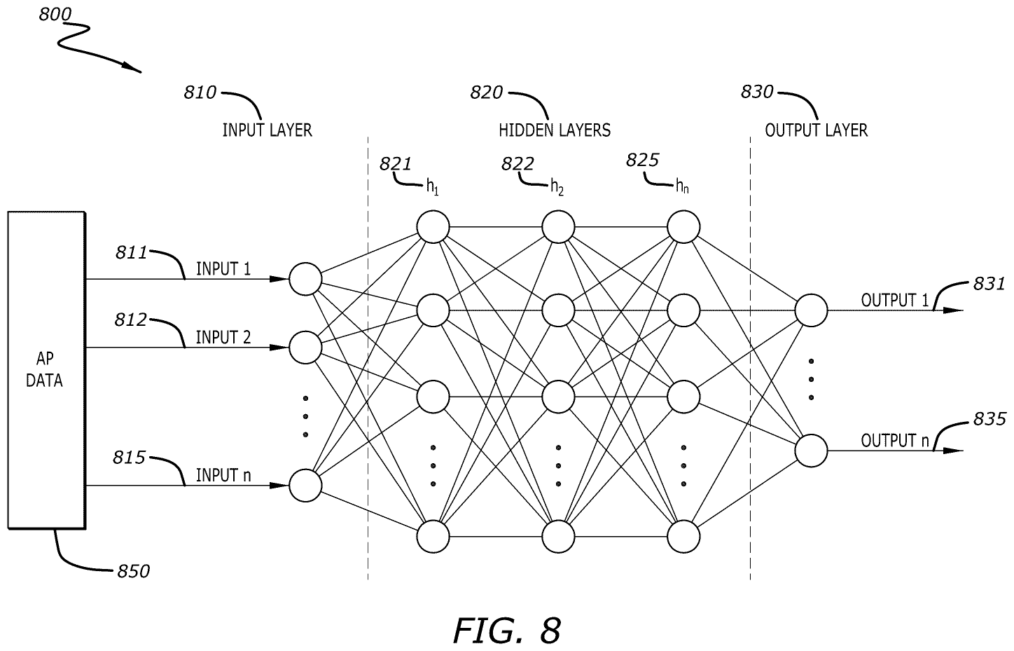

Referring to FIG. 8, an exemplary neural network 800 in accordance with various embodiments of the disclosure is shown. The embodiment depicted specifically depicts a feedforward neural network with multiple layers. This type of network consists of an input layer 810, one or more hidden layers 820, and an output layer 830. Each layer contains nodes (or neurons) that are interconnected, representing how data flows through the network. The input layer 810 can receive raw data, which is then processed by the hidden layers 820 through weighted connections and activation functions. These hidden layers 820 can enable the network to learn complex patterns and relationships within the data.

The final output layer 830 produces the network's predictions or classifications based on the processed input. The interconnected nature of the nodes allows the neural network 800 to learn from data during training by adjusting the weights of connections to minimize prediction errors. This structure is the foundation of deep learning models, as adding more hidden layers 820 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 800 depicted in the embodiment of FIG. 8, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as backpropagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 8 is presented as an exemplary ML solution that may be deployed within one or more methods or systems described herein.

In many embodiments, the input layer 810 is the first layer in a neural network 800 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 800 are generally scaled i.e., normalized to have a zero mean and/or unit standard deviation. Scaling can also be applied to the input of hidden layers (using batch or layer normalization) to improve the stability of neural network 800.

Unlike the hidden layers 820 and the output layers 830, the input layer 810 typically does not perform any computations or transformations on the data. Its primary function is often to pass the input data to the next layer in the network, the first hidden layer 821. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 810 itself does not modify the data, it sets the stage for the neural network to extract complex patterns and relationships through the deeper layers. This flexibility in handling various types of input make the neural network 800 a powerful tool for a diverse set of applications.

With respect to the embodiments described herein, the input layer may be configured with a plurality of inputs providing AP data 850, UWB-enabled AP attributes/parameters or other data sources. For example, a model can be configured with a first input 811 including distance information between at least one UWB-enabled AP and at least one client device, a second input 812 including WLAN RSSI information measured by the UWB-enabled AP, while additional inputs can be added related to the number of potential inputs in the system. The nth input 815 can include correspondence relationship information between the distance information and the WLAN RSSI information. However, as those skilled in the art will recognize, additional setups can be configured such that the inputs can be configured to also include different parameters of the UWB-enabled AP, the number of non-UWB-enabled APs, among other input types, etc.

In a number of embodiments, the neural network 800 comprises a plurality of hidden layers 820. The embodiment depicted in FIG. 8 comprises a first hidden layer 821, a second hidden layer 822, and an nth hidden layer 825, which are denoted as h₁, h₂, and hₙ respectively. In many embodiments, the hidden layers 820 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 821 h₁ receives direct input from the input layer, transforming the raw data into an initial set of features. For example, the first hidden layer 821 h₁ may identify multiple distances between the UWB-enabled AP and the client device, multiple WLAN RSSIs associated with the client device, or the like. The output of the first hidden layer 821 is then passed to a second hidden layer 822 h₂, which builds upon the features identified by the first hidden layer 821. This deeper layer might start recognizing more complex patterns, such as shapes or specific object components, by combining the lower-level features identified earlier. This can continue on until a last, nth hidden layer 825 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 821 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 830 is often the final layer in a neural network and is responsible for producing the network's predictions or classifications based on the information processed through the previous hidden layers 820. Each neuron in the output layer 830 can represent a specific outcome or category that the model can predict. In the embodiment depicted in FIG. 8, the outputs are labeled as “output 1” 831 to “output n,” 835 indicating that the network can be designed to have a varying number of outputs depending on the nature of the problem being solved for. For example, in a binary classification task (e.g., selecting a UWB-enabled AP as the optimal UWB-enabled AP vs the non-optimal UWB-enabled AP), there would typically be a single output neuron that provides a probability score for one of the two classes/outcomes. In contrast, for multi-class classification (e.g., selecting the optimal UWB-enabled AP from a neighbor AP list including multiple UWB-enabled APs and/or a neighbor AP list including a combination of UWB-enabled APs and non-UWB-enabled APs), the output layer would contain multiple neurons, each corresponding to a different class.

The number of neurons in the output layer 830 can also designed specifically for other types of tasks, such as regression, where the model can predict continuous values. In such cases, the output layer 830 might contain a single neuron representing a numerical prediction, such as the price of a house or the temperature forecast, etc. Alternatively, in complex applications like multi-label classification (where each input can belong to multiple classes simultaneously), the output layer 830 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 800 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 8, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 8, which is an illustrative example meant to make it easier to explain the basic concepts of neural networks and how they process information. The specific features and functions described herein are not intended to be limiting to this specific embodiment. Additionally, the elements depicted in FIG. 8 may also be interchangeable with other elements of FIGS. 1-7 and 9-14 as required to realize a particularly desired embodiment.

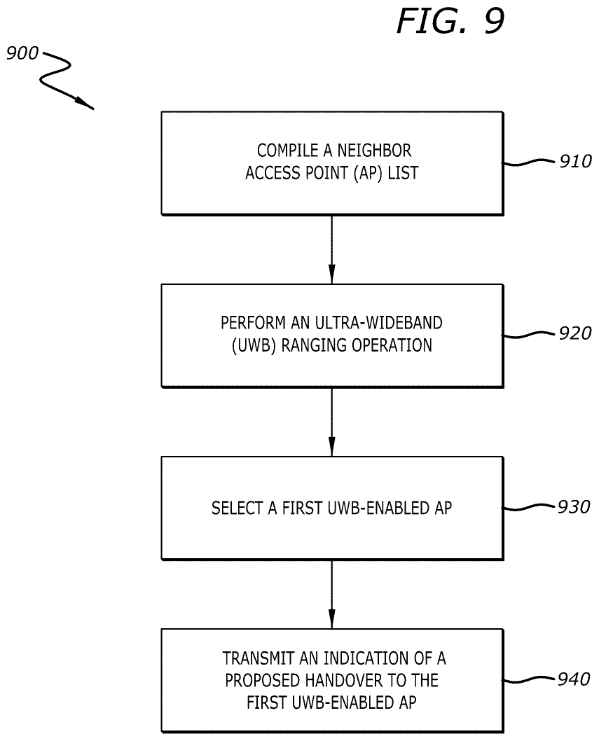

Referring to FIG. 9, a flowchart depicting a process 900 for transmitting a proposed handover indication in accordance with various embodiments of the disclosure is shown. In numerous embodiments, the process 900 may compile a neighbor AP list (block 910). In an example, the neighbor AP list may be compiled by a network device. For example, the network device may correspond to a UWB-enabled AP that allows a client device to connect to the Internet.

In numerous more embodiments, in order to compile the neighbor AP list, the process 900 may execute an NDP. Upon executing the NDP, the process 900 may transmit, to at least one neighboring AP of the network device, at least one NS message requesting one or more identifiers of the neighboring AP and/or channel information of the neighboring AP. In response to transmitting the NS message, the process 900 may receive at least one NA message from the neighboring AP. For example, the NA message may include a connectivity identifier of the neighboring AP, a UWB identifier of the neighboring AP, UWB channel information of the neighboring AP, and/or a WLAN RSSI threshold of the neighboring AP. For example, the connectivity identifier of the neighboring AP may include a MAC address of a Wi-Fi interface of the neighboring AP. The UWB identifier of the neighboring AP may include a MAC address of a UWB interface (or a UWB device) of the neighboring AP. The UWB channel information of the neighboring AP may indicate a UWB channel of the neighboring AP. The WLAN RSSI threshold may represent a specific RSSI value, above which the UWB channel of the neighboring AP is likely to be reachable. Upon receiving the NA message, the process 900 may compile the neighbor AP list to include information about neighboring APs. In an example, the neighbor AP list may be compiled to include the received NA message.

In many embodiments, the process 900 may perform a UWB ranging operation (block 920). In an example, the network device may perform the UWB ranging operation against the client device. In order to perform the UWB ranging operation, the process 900 may broadcast at least one OOB announcement indicating a presence of the network device. If the client device is located within a communication range of the network device, the OOB announcement may be received by the client device. As used herein, the communication range of the network device may encompass a specific geographical area serviced by the network device. In response to broadcasting the OOB announcement, the process 900 may receive, from the client device, an association request indicating that the client device wants to join a network associated with the network device. Upon receiving the association request, the process 900 may allow the client device to join the network. Upon allowing the client device to join the network, the process 900 may execute the UWB ranging operation against the client device.

In a variety of embodiments, the UWB ranging operation may include a TWR operation. Upon executing the TWR operation, the network device may execute a ranging exchange to the client device by exchanging one or more UWB signals with the client device. Further, the network device may determine a round-trip time associated with the UWB signals, and determine a distance between the network device and the client device by utilizing the determined round-trip time. In many further embodiments, the UWB ranging operation may include two or more rounds of ranging exchanges. In many additional embodiments, the process 900 may determine a movement vector of the client device relative to the network device based on the two or more rounds of ranging exchanges. In an example, the movement vector may include a radial speed vector indicating the speed at which the client device is moving either toward or away from the network device.

In more embodiments, the process 900 may select a first UWB-enabled AP (block 930). In an example, the network device may select the first UWB-enabled AP from the neighbor AP list. For example, if the client device is moving away from the network device, the process 900 may select, as the first UWB-enabled AP, a UWB-enabled AP having the highest WLAN RSSI value among the neighbor AP list (e.g., the UWB-enabled AP that is close to the network device among the neighbor AP list).

In further embodiments, the process 900 may transmit an indication of a proposed handover to the first UWB-enabled AP (block 940). In an example, the network device may transmit, to the client device, the indication of the proposed handover in order to inform the client device about the neighboring AP that supports the UWB technology. In still further embodiments, the process 900 may transmit, to the client device, the indication of the proposed handover via a WLAN action frame. In an example, the indication of the proposed handover may include a UWB identifier of the first UWB-enabled AP, UWB channel information of the first UWB-enabled AP, and/or an indication of a WLAN RSSI threshold of the first UWB-enabled AP.

Although a specific embodiment of the process 900 for carrying out the various steps, processes, methods, and operations described herein is discussed with respect to FIG. 9, any of a variety of systems and/or processes may be utilized in accordance with embodiments of the disclosure. For example, the first UWB-enabled AP may be selected from the neighbor AP list by executing an ML model based on the plurality of correspondence relationships and the neighbor AP list. The elements depicted in FIG. 9 may also be interchangeable with other elements of FIGS. 1-8 and 10-14 as required to realize a particularly desired embodiment.

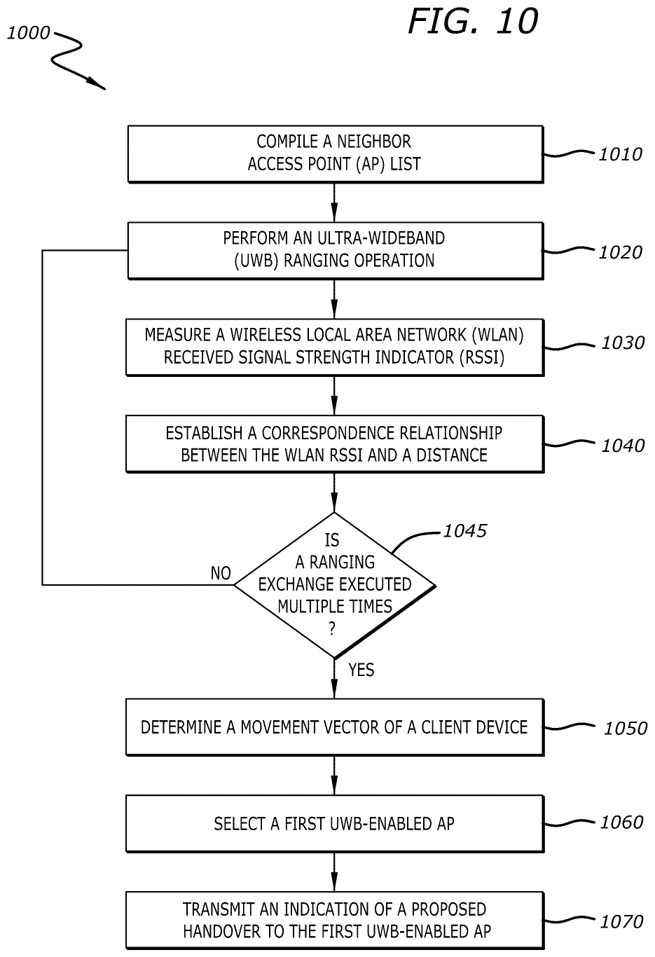

Referring to FIG. 10, a flowchart depicting a process 1000 for handing over a client device in accordance with various embodiments of the disclosure is shown. In numerous embodiments, the process 1000 may compile a neighbor AP list (block 1010). In an example, the neighbor AP list may be compiled by a network device. For example, the network device may correspond to a UWB-enabled AP that allows a client device to connect to the Internet. In order to compile the neighbor AP list, the network device may execute an NDP. Upon executing the NDP, the network device may exchange at least one NA message with its neighboring AP. For example, the network device may an NA message from the neighboring AP. In an example, the NA message may include a connectivity identifier of the neighboring AP, a UWB identifier of the neighboring AP, UWB channel information of the neighboring AP, and/or a WLAN RSSI threshold of the neighboring AP. Upon receiving the NA message, the network device may compile the neighbor AP list to include information about the neighboring AP. In an example, the neighbor AP list may be compiled to include the received NA message.

In many embodiments, the process 1000 may perform a UWB ranging operation (block 1020). In an example, the network device may perform the UWB ranging operation against the client device. In order to perform the UWB ranging operation, the network device may determine whether an association request is received from the client device. If the association request is not received, the network device may wait until the association request is received from the client device and/or may broadcast an OOB announcement indicating a presence of the network device. If the association request is received, the network device may allow the client device to join the network. Upon allowing the client device to join the network, the network device may execute the UWB ranging operation against the client device. In a variety of embodiments, the UWB ranging operation may include a TWR operation. Upon executing the TWR operation, the network device may execute a ranging exchange to the client device. Upon executing the ranging exchange, the network device may exchange one or more UWB signals with the client device and determine a round-trip time associated with the UWB signals. Further, the network device may determine a distance between the network device and the client device by utilizing the determined round-trip time.

In more embodiments, the process 1000 may measure a WLAN RSSI (block 1030). In an example, upon determining the distance between the network device and the client device, the network device may measure the WLAN RSSI associated with the client device. Specifically, the process 1000 may measure the WLAN RSSI associated with a wireless signal of the client device.

In still more embodiments, the process 1000 may establish a correspondence relationship between the measured WLAN RSSI and the determined distance (block 1040). In an example, the network device may establish the correspondence relationship between the measured WLAN RSSI and the determined distance. For example, the correspondence relationship may indicate that the measured WLAN RSSI is mapped to the determined distance.

In yet more embodiments, the process 1000 may determine whether the ranging exchange is executed multiple times (block 1045). In an example, the network device may determine whether the ranging exchange is executed multiple times. In still yet more embodiments, if the ranging exchange is not executed multiple times, the process 1000 may again perform the UWB ranging operation (block 1020), measure the WLAN RSSI associated with the client (block 1030), and establish the corresponding relationship (block 1040). As a result, the network device may obtain multiple distances between the client device and the network device, multiple WLAN RSSIs associated with the client device, and multiple correspondence relationships between the distances and the WLAN RSSIs.

In further embodiments, if the ranging exchange is executed multiple times, the process 1000 may determine a movement vector of the client device (block 1050). In an example, the network device may determine the movement vector of the client device relative to the network device. For example, the movement vector may be determined based on two or more rounds of the ranging exchanges. In an example, the movement vector may include a radial speed vector indicating the speed at which the client device is moving either toward or away from the network device.

In several embodiments, the process 1000 may select a first UWB-enabled AP (block 1060). In an example, the network device may select the first UWB-enabled AP from the neighbor AP list based on the correspondence relationships and the determined movement vector. In several more embodiments, in order to select the first UWB-enabled AP from the neighbor AP list, the process 1000 may execute an ML model based on the correspondence relationships, the determined movement vector, and the neighbor AP list. In a number of embodiments, the ML model may be pre-trained to output a selection of UWB-enabled AP from the neighbor AP list by learning the correspondence relationships, the determined movement vector, and the neighbor AP list. For instance, the ML model may include an ensemble learning model, an SVM, or the like.

In various embodiments, the process 1000 may transmit, to the client device, an indication of a proposed handover to the first UWB-enabled AP (block 1070). In an example, the network device may transmit, to the client device, the indication of the proposed handover to the first UWB-enabled AP. In a number of embodiments, the indication of the proposed handover may be transmitted via a WLAN action frame. For example, the indication of the proposed handover may be transmitted to the client device in order to inform the client device about the neighboring AP that supports the UWB technology. In an example, the indication of the proposed handover may include a UWB identifier of the first UWB-enabled AP, UWB channel information of the first UWB-enabled AP, and/or an indication of a WLAN RSSI threshold of the first UWB-enabled AP.

Although a specific embodiment of the process 1000 for carrying out the various steps, processes, methods, and operations described herein is discussed with respect to FIG. 10, any of a variety of systems and/or processes may be utilized in accordance with embodiments of the disclosure. For example, the TWR operation may correspond to a DS-TWR operation in which both the client device and the network device may perform two or more rounds of the ranging exchanges to determine the distances between the client device and the network device. The elements depicted in FIG. 10 may also be interchangeable with other elements of FIGS. 1-9 and 11-14 as required to realize a particularly desired embodiment.

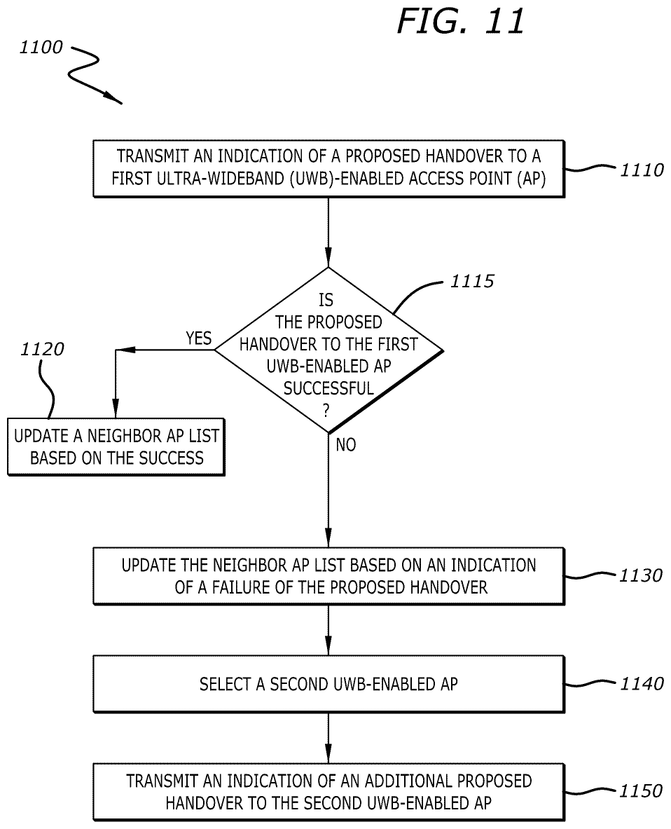

Referring to FIG. 11, a flowchart depicting a process 1100 for transmitting an additional proposed handover indication in accordance with various embodiments of the disclosure is shown. In a variety of embodiments, the process 1100 may transmit, to a client device, an indication of a proposed handover to a first UWB-enabled AP (block 1110). In an example, the indication of the proposed handover may be transmitted by a network device. For example, the network device may correspond to a UWB-enabled AP that allows the client device to connect to the Internet.

In a number of embodiments, the network device may transmit, to the client device, the indication of the proposed handover via a WLAN action frame. For example, the indication of the proposed handover may include a UWB identifier of the first UWB-enabled AP, UWB channel information of the first UWB-enabled AP, and/or an indication of a WLAN RSSI threshold of the first UWB-enabled AP. Upon receiving the indication of the proposed handover, a UWB ranging operation to the first UWB-enabled AP may be attempted by the client device. For example, the UWB ranging operation may include a TWR operation in which the client device exchanges one or more UWB signals with the first UWB-enabled AP to determine at least one distance between the client device and the first UWB-enabled AP. The attempt made by the client device may result in a success or a failure based on the location of the client device relative to the first UWB-enabled AP. If the attempt results in the failure, an indication of the failure of the proposed handover to the first UWB-enabled AP may be transmitted by the client device to the network device. Conversely, if the attempt results in the success, the client device may prohibit the transmission of the indication of the failure of the proposed handover to the network device.

In numerous embodiments, the process 1100 may determine whether the proposed handover to the first UWB-enabled AP is successful (block 1115). In an example, the network device may determine whether the proposed handover to the first UWB-enabled AP is successful. For example, the process 1100 may determine that the proposed handover to the first UWB-enabled AP is successful based on an absence of the indication of the failure of the proposed handover. Conversely, if the process 1100 receives the indication of the failure of the proposed handover from the client device, the process 1100 may determine that the proposed handover to the first UWB-enabled AP is unsuccessful.

In numerous more embodiments, if the proposed handover to the first UWB-enabled AP is successful, the process 1100 may update a neighbor AP list based on the success of the proposed handover (block 1120). In an example, the network device may update the neighbor AP list associated with the network device based on the success of the proposed handover. For example, if the network device has the first UWB-enabled AP and a second UWB-enabled AP as neighboring APs, the neighbor AP list associated with the network device may include information (e.g., connectivity identifiers, UWB identifiers, UWB channel information, or the like) about the first UWB-enabled AP and the second UWB-enabled AP. For instance, the process 1100 may update the neighbor AP list to indicate that the proposed handover to the first UWB-enabled AP is successful.

In many embodiments, if the proposed handover to the first UWB-enabled AP is unsuccessful, the process 1100 may update the neighbor AP list based on the indication of the failure of the proposed handover (block 1130). In an example, the network device may update the neighbor AP list associated with the network device based on the indication of the failure of the proposed handover. For example, the neighbor AP list may be updated to remove the first UWB-enabled AP from the neighbor AP list or indicate that the proposed handover to the first UWB-enabled AP is unsuccessful.

In many additional embodiments, the process 1100 may utilize an ML process to update the neighbor AP list. In an example, the ML process may include executing an ML model to update the neighbor AP list. For example, the process 1100 may execute the ML model by inputting the indication of the failure and the neighbor AP list into the ML model. The ML model may be pre-trained to either remove a specific UWB-enabled AP from the neighbor AP list or indicate that a handover to the specific UWB-enabled AP is unsuccessful by learning the neighbor AP list and an indication of a failure of the handover to the specific UWB-enabled AP. For instance, the ML model may include an ensemble learning model, an SVM, or the like.

In many further embodiments, the process 1100 may select the second UWB-enabled AP (block 1140). In an example, the network device may select the second UWB-enabled AP from the updated neighbor AP list associated with the network device. In further embodiments, in order to select the second UWB-enabled AP, the process 1100 may perform the UWB ranging operation against the client device. For example, the UWB ranging operation may include two or more rounds of ranging exchanges. In order to execute the two or more rounds of ranging exchanges, the network device may execute a ranging exchange at a plurality of different time instances. Upon executing the ranging exchange at a specific time instance of the plurality of different time instances, the network device may exchange one or more UWB signals with the client device, and determine at least one distance between the client device and the network device based on a round-trip time associated with the one or more UWB signals. Based on executing the two or more rounds of ranging exchanges, the process 1100 may determine a plurality of distances between the client device and the network device.

In still further embodiments, the process 1100 may obtain a plurality of WLAN RSSIs associated with the client device for the plurality of distances. In an example, the plurality of WLAN RSSIs may be obtained by measuring a WLAN RSSI associated with the client device at each time instance of the plurality of different time instances. Further, the process 1100 may establish a plurality of correspondence relationships between the plurality of distances and the plurality of WLAN RSSIs. For example, each correspondence relationship of the plurality of correspondence relationships may indicate a specific distance of the plurality of distances is mapped to a respective WLAN RSSI of the plurality of WLAN RSSIs.

In still yet further embodiments, the process 1100 may determine a movement vector of the client device relative to the network device based on the two or more rounds of ranging exchanges. In an example, the movement vector may include a radial speed vector indicating the speed at which the client device is moving either toward or away from the network device. For example, the radial speed vector may be determined based on the plurality of distances and the plurality of different time instances.

In further additional embodiments, the process 1100 may select the second UWB-enabled AP from the updated neighbor AP list based on the plurality of correspondence relationships and/or the determined movement vector. In additional embodiments, the process 1100 may execute the ML model to select the second UWB-enabled AP. The ML may be further pre-trained to output a selection of one or more further UWB-enabled APs from the updated neighbor AP list for one or more further proposed handovers by learning input data. For example, the network device may execute the ML model by inputting the plurality of correspondence relationships, the determined movement vector, and/or the updated neighbor AP list into the ML model. Upon executing the ML model, the process 1100 may select the second UWB-enabled AP from the updated neighbor AP list.

In various embodiments, the process 1100 may transmit, to the client device, an indication of an additional proposed handover to the second UWB-enabled AP (block 1150). In an example, the network device may transmit, to the client device, the indication of the additional proposed handover to the second UWB-enabled AP. In several embodiments, the indication of the additional proposed handover may be transmitted via the WLAN action frame. For example, the indication of the additional proposed handover may include a UWB identifier of the second UWB-enabled AP, UWB channel information of the second UWB-enabled AP, and/or an indication of a WLAN RSSI threshold of the second UWB-enabled AP.

Although a specific embodiment of the process 1100 for carrying out the various steps, processes, methods, and operations described herein is discussed with respect to FIG. 11, any of a variety of systems and/or processes may be utilized in accordance with embodiments of the disclosure. For example, the neighbor AP list of the network device may be updated based on the success of the proposed handover by executing the ML model. In this example, the ML model may be further pre-trained to indicate that the proposed handover to the first UWB-enabled AP is successful if the network device does not receive an indication of the failure of the proposed handover to the first UWB-enabled AP for a predefined time duration. The elements depicted in FIG. 11 may also be interchangeable with other elements of FIGS. 1-10 and 12-14 as required to realize a particularly desired embodiment.

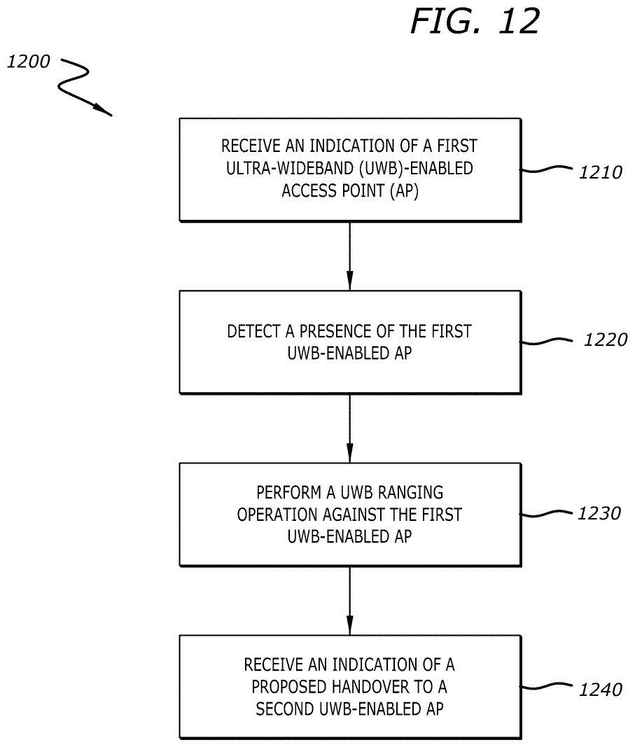

Referring to FIG. 12, a flowchart depicting a process 1200 for receiving a proposed handover indication in accordance with various embodiments of the disclosure is shown. In a variety of embodiments, the process 1200 may receive an indication of a first UWB-enabled AP (block 1210). In an example, the indication of the first UWB-enabled AP may be received by a client device. For example, the client device may include a mobile computing device that supports Wi-Fi, Bluetooth, and/or the UWB technology.

In a number of embodiments, the process 1200 may receive one or more OOB announcements made by the first UWB-enabled AP. The OOB announcements may include the indication of the first UWB-enabled AP. For example, the indication of the first UWB-enabled AP may include a connectivity identifier of the first UWB-enabled AP, a UWB identifier of the first UWB-enabled AP, UWB channel information of the first UWB-enabled AP, and/or a WLAN RSSI threshold of the first UWB-enabled AP. For example, the connectivity identifier of the first UWB-enabled AP may include a MAC address of a Wi-Fi interface of the first UWB-enabled AP. The UWB identifier of the first UWB-enabled AP may include a MAC address of a UWB interface (or a UWB device) of the first UWB-enabled AP. The UWB channel information of the neighboring AP may indicate a UWB channel of the first UWB-enabled AP. The WLAN RSSI threshold may represent a specific RSSI value, above which the UWB channel of the first UWB-enabled AP is likely to be reachable.

In many embodiments, the process 1200 may detect a presence of the first UWB-enabled AP (block 1220). In an example, the client device may detect the presence of the first UWB-enabled AP based on the reception of the indication of the first UWB-enabled AP. For example, the process 1200 may detect the presence of the first UWB-enabled AP by extracting one or more identifiers of the first UWB-enabled AP from the indication of the first UWB-enabled AP. Upon detecting the presence of the first UWB-enabled AP, the process 1200 may transmit an association request to the first UWB-enabled AP. For example, the association request may indicate that the client device wants to join a network associated with the first UWB-enabled AP. Upon transmitting the association request, the process 1200 may be allowed to join the network by the first UWB-enabled AP.

In more embodiments, the process 1200 may perform a UWB ranging operation against the first UWB-enabled AP (block 1230). In an example, the client device may perform the UWB ranging operation against the first UWB-enabled AP. In order to perform the UWB ranging operation, the process 1200 may measure a WLAN RSSI associated with a wireless signal of the first UWB-enabled AP. Further, the process 1200 may determine whether the measured WLAN RSSI is greater than the WLAN RSSI threshold of the first UWB-enabled AP by comparing the measured WLAN RSSI with the WLAN RSSI threshold. If the measured WLAN RSSI is not greater than the WLAN RSSI threshold, the process 1200 may iteratively measure the WLAN RSSI for a specific time duration or until the WLAN RSSI exceeds the WLAN RSSI threshold. Conversely, if the measured WLAN RSSI is greater than the WLAN RSSI threshold, the process 1200 may execute the UWB ranging operation against the first UWB-enabled AP. In still more embodiments, the UWB ranging operation may include a DS-TWR operation having two or more rounds of ranging exchanges.

In further embodiments, the process 1200 may receive an indication of a proposed handover to a second UWB-enabled AP (block 1240). For example, the client device may receive the indication of the proposed handover to the second UWB-enabled AP from the first UWB-enabled AP. In an example, the indication of the proposed handover may be received via a WLAN action frame. In various embodiments, the indication of the proposed handover may include a UWB identifier of the second UWB-enabled AP, UWB channel information of the second UWB-enabled AP, and/or an indication of a WLAN RSSI threshold of the second UWB-enabled AP.

Although a specific embodiment of the process 1200 for carrying out the various steps, processes, methods, and operations described herein is discussed with respect to FIG. 12, any of a variety of systems and/or processes may be utilized in accordance with embodiments of the disclosure. For example, the client device may further utilize the indication of the proposed handover to perform a subsequent UWB ranging operation against the second UWB-enabled AP. The elements depicted in FIG. 12 may also be interchangeable with other elements of FIGS. 1-11 and 13-14 as required to realize a particularly desired embodiment.

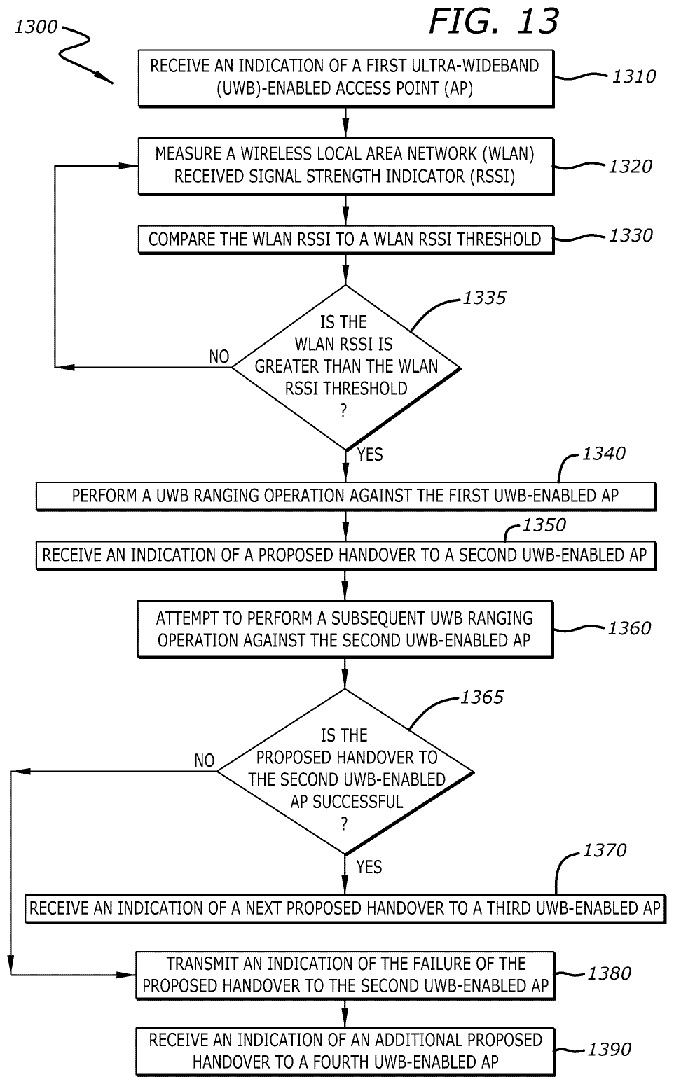

Referring to FIG. 13, a flowchart depicting a process 1300 for receiving an additional proposed handover indication in accordance with various embodiments of the disclosure is shown. In a variety of embodiments, the process 1300 may receive an indication of a first UWB-enabled AP (block 1310). In an example, the indication of the first UWB-enabled AP may be received by a client device. For example, the client device may include a mobile computing device that supports Wi-Fi, Bluetooth, and/or the UWB technology. In a number of embodiments, the indication of the first UWB-enabled AP may include a connectivity identifier of the first UWB-enabled AP, a UWB identifier of the first UWB-enabled AP, UWB channel information of the first UWB-enabled AP, and/or a WLAN RSSI threshold of the first UWB-enabled AP. Further, the process 1300 may detect a presence of the first UWB-enabled AP based on the reception of the indication of the first UWB-enabled AP. In various embodiments, the indication of the first UWB-enabled AP may be received via an OOB announcement from the first UWB-enabled AP.

In many embodiments, the process 1300 may measure a WLAN RSSI associated with the first UWB-enabled AP (block 1320). In an example, the client device may measure the WLAN RSSI associated with the first UWB-enabled AP. Specifically, the process 1300 may measure the WLAN RSSI associated with a wireless signal (e.g., a Wi-Fi signal) of the first UWB-enabled AP.

In many further embodiments, the process 1300 may compare the measured WLAN RSSI to the WLAN RSSI threshold of the first UWB-enabled AP (block 1330). In an example, the client device may compare the measured WLAN RSSI to the WLAN RSSI threshold of the first UWB-enabled AP. Upon comparing the measured WLAN RSSI to the WLAN RSSI threshold, the process 1300 may obtain a comparison result. The comparison result may indicate one of the WLAN RSSI is greater than the WLAN RSSI threshold, the WLAN RSSI is lesser than the WLAN RSSI threshold, or the WLAN RSSI is equal to the WLAN RSSI threshold.

In further embodiments, the process 1300 may determine whether the WLAN RSSI is greater than the WLAN RSSI threshold (block 1335). In an example, the client device may determine whether the WLAN RSSI is greater than the WLAN RSSI threshold. For example, the process 1300 may determine whether the WLAN RSSI is greater than the WLAN RSSI threshold based on the comparison result. In still further embodiments, if the WLAN RSSI is not greater than the WLAN RSSI threshold, the process 1300 may again measure the WLAN RSSI (block 1320). In an example, the measurement of the WLAN RSSI may be repeatedly performed for a specific time duration or until the WLAN RSSI exceeds the WLAN RSSI threshold.

In still yet further embodiments, if the WLAN RSSI is greater than the WLAN RSSI threshold, the process 1300 may perform a UWB ranging operation against the first UWB-enabled AP (block 1340). In an example, the client device may perform the UWB ranging operation against the first UWB-enabled AP. In more embodiments, the UWB ranging operation may include a DS-TWR operation having two or more rounds of ranging exchanges. In order to execute the two or more rounds of ranging exchanges, the process 1300 may execute a ranging exchange at a plurality of different time instances based on the UWB identifier of the first UWB-enabled AP and/or the UWB channel information of the first UWB-enabled AP. Upon executing the two or more rounds of ranging exchanges, both the client device and the first UWB-enabled AP may determine a plurality of distances between the client device and the first UWB-enabled AP. Further, a plurality of WLAN RSSIs associated with the client device for the plurality of distances may be obtained by the first UWB-enabled AP. In an example, the plurality of WLAN RSSIs may be obtained by measuring a WLAN RSSI associated with the client device at each time instance of the plurality of different time instances.

In still more embodiments, upon obtaining the plurality of WLAN RSSIs, a plurality of correspondence relationships between the plurality of distances and the plurality of WLAN RSSIs may be established by the first UWB-enabled AP. In an example, each correspondence relationship of the plurality of correspondence relationships may indicate a specific distance of the plurality of distances is mapped to a respective WLAN RSSI of the plurality of WLAN RSSIs.

In numerous embodiments, the process 1300 may receive an indication of a proposed handover to a second UWB-enabled AP (block 1350). For example, the client device may receive the indication of the proposed handover to the second UWB-enabled AP from the first UWB-enabled AP. In an example, the second UWB-enabled AP may be selected from a neighbor AP list associated with the first UWB-enabled AP for the proposed handover based on the plurality of correspondence relationships. In further examples, the indication of the proposed handover may be received via a WLAN action frame. In various embodiments, the indication of the proposed handover may include a UWB identifier of the second UWB-enabled AP, UWB channel information of the second UWB-enabled AP, and/or an indication of a WLAN RSSI threshold of the second UWB-enabled AP.

In numerous more embodiments, the process 1300 may attempt to perform a subsequent UWB ranging operation against the second UWB-enabled AP (block 1360). In an example, the client device may attempt to perform the subsequent UWB ranging operation against the second UWB-enabled AP using the UWB identifier of the second UWB-enabled AP and/or the UWB channel information of the second UWB-enabled AP. For example, the attempt may result in a success if the client device is located within a UWB range of the second UWB-enabled AP (or if a WLAN RSSI associated with the second UWB-enabled AP is greater than the WLAN RSSI threshold of the second UWB-enabled AP). Conversely, if the client device is not located within a UWB range of the second UWB-enabled AP, the attempt may result in a failure. In yet more embodiments, if the attempt results in the failure, the process 1300 may repeatedly attempt to perform the subsequent UWB ranging operation for a predefined number of times in anticipation that the WLAN RSSI associated with the second UWB-enabled AP exceeds the WLAN RSSI threshold of the second UWB-enabled AP.

In still yet more embodiments, if the attempt results in the success, the process 1300 may execute the subsequent UWB ranging operation against the second UWB-enabled AP. In an example, the subsequent UWB ranging operation may include the DS-TWR operation having the two or more rounds of ranging exchanges. Upon executing the two or more rounds of ranging exchanges, both the client device and the second UWB-enabled AP may determine a plurality of distances between the client device and the second UWB-enabled AP. Further, a plurality of WLAN RSSIs associated with the client device for the plurality of distances may be obtained by the second UWB-enabled AP. Upon obtaining the plurality of WLAN RSSIs, a plurality of correspondence relationships between the plurality of distances and the plurality of WLAN RSSIs may be established by the second UWB-enabled AP.

In additional embodiments, the process 1300 may determine whether the proposed handover to the second UWB-enabled AP is successful (block 1365). In an example, the client device may determine whether the proposed handover to the second UWB-enabled AP is successful. For example, the process 1300 may determine that the proposed handover to the second UWB-enabled AP is successful if the attempt to perform the subsequent UWB ranging operation results in the success. Conversely, if the attempt to perform the subsequent UWB ranging operation results in the failure, the process 1300 may determine that the proposed handover to the second UWB-enabled AP is unsuccessful.

In still additional embodiments, if the proposed handover to the second UWB-enabled AP is successful, the process 1300 may receive an indication of a next proposed handover to a third UWB-enabled AP (block 1370). For example, the client device may receive the indication of the next proposed handover to the third UWB-enabled AP from the second UWB-enabled AP. In an example, the indication of the next proposed handover may be received via the WLAN action frame. For instance, the indication of the next proposed handover may include a UWB identifier of the third UWB-enabled AP, UWB channel information of the third UWB-enabled AP, and/or an indication of a WLAN RSSI threshold of the third UWB-enabled AP.

In still yet additional embodiments, if the proposed handover to the second UWB-enabled AP is unsuccessful, the process 1300 may transmit an indication of the failure of the proposed handover to the second UWB-enabled AP (block 1380). In an example, the client device may transmit, to the first UWB-enabled AP, an indication of the failure of the proposed handover to the second UWB-enabled AP. For example, the indication of the failure may be transmitted via a WLAN action frame response.

In further additional embodiments, the process 1300 may receive an indication of an additional proposed handover to a fourth UWB-enabled AP (block 1390). For example, the client device may receive the indication of the additional proposed handover to the fourth UWB-enabled AP from the first UWB-enabled AP. The fourth UWB-enabled AP may be selected from an updated neighbor AP list by the first UWB-enabled AP. In an example, the indication of the additional proposed handover may be received via the WLAN action frame. For instance, the indication of the additional proposed handover may include a UWB identifier of the fourth UWB-enabled AP, UWB channel information of the fourth UWB-enabled AP, and/or an indication of a WLAN RSSI threshold of the fourth UWB-enabled AP.

Although a specific embodiment of the process 1300 for carrying out the various steps, processes, methods, and operations described herein is discussed with respect to FIG. 13, any of a variety of systems and/or processes may be utilized in accordance with embodiments of the disclosure. For example, the client device may further perform the subsequent UWB ranging operation against the fourth UWB-enabled AP based on the indication of the additional proposed handover. The elements depicted in FIG. 13 may also be interchangeable with other elements of FIGS. 1-12 and 14 as required to realize a particularly desired embodiment.

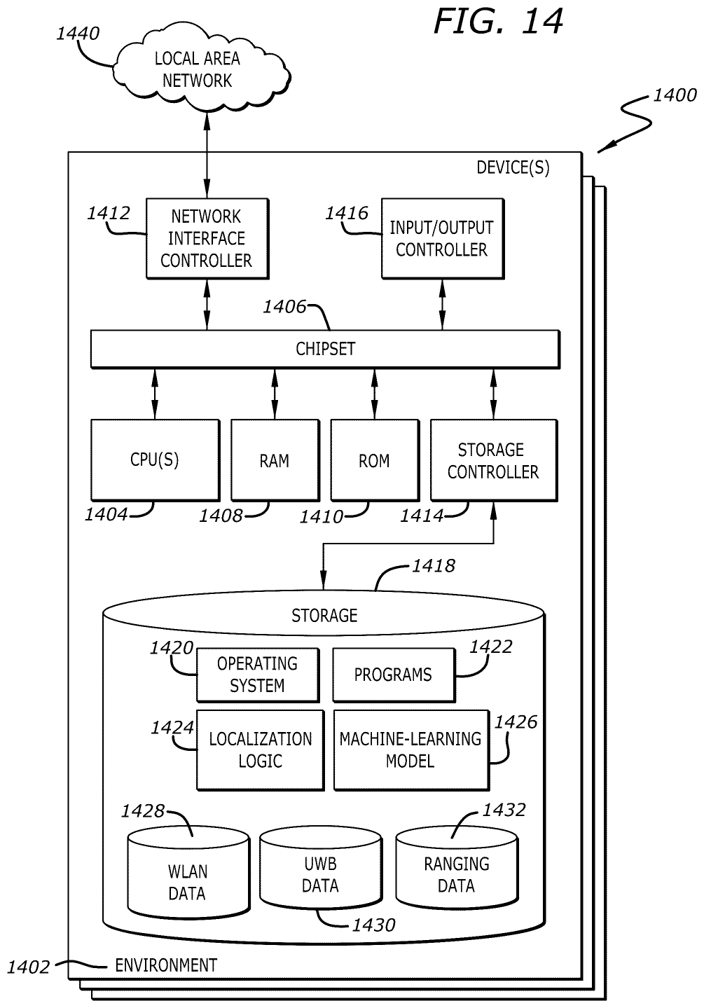

Referring to FIG. 14, a conceptual block diagram of a device 1400 suitable for configuration with a localization logic in accordance with various embodiments of the disclosure is shown. The embodiment of the conceptual block diagram depicted in FIG. 14 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 14 can also illustrate an access point, a switch, or a router in accordance with various embodiments of the disclosure. The device 1400 may, in many non-limiting examples, correspond to physical devices or to virtual resources described herein.

In many embodiments, the device 1400 (e.g., a UWB-enabled AP or a client device) may include an environment 1402 such as a baseboard or “motherboard,” in physical embodiments that can be configured as a printed circuit board with a multitude of components or devices connected by way of a system bus or other electrical communication paths. Conceptually, in virtualized embodiments, the environment 1402 may be a virtual environment that encompasses and executes the remaining components and resources of the device 1400. In more embodiments, one or more processors 1404, such as, but not limited to, central processing units (“CPUs”) can be configured to operate in conjunction with a chipset 1406. The processor(s) 1404 can be standard programmable CPUs that perform arithmetic and logical operations necessary for the operation of the device 1400.

In a number of embodiments, the processor(s) 1404 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1406 may provide an interface between the processor(s) 1404 and the remainder of the components and devices within the environment 1402. The chipset 1406 can provide an interface to a random-access memory (“RAM”) 1408, which can be used as the main memory in the device 1400 in some embodiments. The chipset 1406 can further be configured to provide an interface to a computer-readable storage medium such as a read-only memory (“ROM”) 1410 or non-volatile RAM (“NVRAM”) for storing basic routines that can help with various tasks such as, but not limited to, starting up the device 1400 or transferring information between the various components and devices. The ROM 1410 or NVRAM can also store other application components necessary for the operation of the device 1400 in accordance with various embodiments described herein.

Additional embodiments of the device 1400 can be configured to operate in a networked environment using logical connections to remote computing devices and computer systems through a network, such as the network 1440. The chipset 1406 can include functionality for providing network connectivity through a network interface card (“NIC”) 1412, which may comprise a gigabit Ethernet adapter or similar component. The NIC 1412 can be capable of connecting the device 1400 to other devices over the network 1440. It is contemplated that multiple NICs 1412 may be present in the device 1400, connecting the device to other types of networks and remote systems.

In further embodiments, the device 1400 can be connected to a storage 1418 that provides non-volatile storage for data accessible by the device 1400. The storage 1418 can, for instance, store an operating system 1420, applications 1422 (denoted as “programs” in FIG. 14), WLAN data 1428, UWB data 1430, and ranging data 1432 which are described in greater detail below. The storage 1418 can be connected to the environment 1402 through a storage controller 1414 connected to the chipset 1406. In certain embodiments, the storage 1418 can consist of one or more physical storage units. The storage controller 1414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1400 can store data within the storage 1418 by transforming the physical state of the physical storage units to reflect the information being stored. The specific transformation of physical state can depend on various factors. Examples of such factors can include, but are not limited to, the technology used to implement the physical storage units, whether the storage 1418 is characterized as primary or secondary storage, and the like.

In still more embodiments, the device 1400 can store information within the storage 1418 by issuing instructions through the storage controller 1414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1400 can further read or access information from the storage 1418 by detecting the physical states or characteristics of one or more particular locations within the physical storage units.

In addition to the storage 1418 described above, the device 1400 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1400. In some examples, the operations performed by a cloud computing network, and or any components included therein, may be supported by one or more devices similar to device 1400. Stated otherwise, some or all of the operations performed by the cloud computing network, and or any components included therein, may be performed by one or more devices 1400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1418 can store an operating system 1420 utilized to control the operation of the device 1400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1418 can store other system or application programs and data utilized by the device 1400.

In many additional embodiments, the storage 1418 or other computer-readable storage media is encoded with computer-executable instructions which, when loaded into the device 1400, may transform it from a general-purpose computing system into a special-purpose computer capable of implementing the embodiments described herein. These computer-executable instructions may be stored as application 1422 and transform the device 1400 by specifying how the processor(s) 1404 can transition between states, as described above. In some embodiments, the device 1400 has access to computer-readable storage media storing computer-executable instructions which, when executed by the device 1400, perform the various processes described above with regard to FIGS. 1-13. In certain embodiments, the device 1400 can also include computer-readable storage media having instructions stored thereupon for performing any of the other computer-implemented operations described herein.

In many further embodiments, the device 1400 may include a localization logic 1424. The localization logic 1424 can be configured to perform one or more of the various steps, processes, operations, or other methods that are described above. Often, the localization logic 1424 can be a set of instructions stored within a non-volatile memory that, when executed by the processor(s) 1404 can carry out these steps, etc. In some embodiments, the localization logic 1424 may be a client application that resides on a network-connected device, such as, but not limited to, a server, switch, personal or mobile computing device in a single or distributed arrangement.

Various embodiments are based on the recognition that the location determination of a client device may be accurately performed by forming Time Difference of Arrival (TDoA) clusters of a plurality of UWB-enabled APs. Some more embodiments are based on the realization that UWB ranges of the plurality of UWB-enabled APs may be shorter than that of other wireless technologies (e.g., Wi-Fi, Bluetooth, or the like) supported by the plurality of UWB-enabled APs. According to some more embodiments, the limitation of the UWB ranges of the plurality of UWB-enabled APs may pose a significant challenge in the formation of Time Difference of Arrival (TDoA) clusters. To that end, in a number of embodiments, the TDoA technique may be replaced with a TWR technique that allows the client device to directly exchange messages with individual UWB-enabled APs.

Several more embodiments are based on the understanding that the TWR technique is silent on guiding the client device in identifying and selecting additional UWB-enabled APs for subsequent ranging. To this end, in numerous embodiments, when the device 1400 is configured as the UWB-enabled AP, the localization logic 1424 may be configured to provide at least one UWB handover recommendation to the client device in order to inform the client device about at least one neighboring UWB-enabled AP. In an example, the UWB handover recommendation may include an indication of a proposed handover to the neighboring UWB-enabled AP. For example, the indication of the proposed handover may include a UWB identifier of the neighboring UWB-enabled AP, UWB channel information of the neighboring UWB-enabled AP, and/or a WLAN RSSI threshold of the neighboring UWB-enabled AP. In numerous more embodiments, when the device 1400 is configured as the client device, the localization logic 1424 may be configured to utilize the UWB handover recommendation to perform at least one subsequent UWB ranging operation against the neighboring UWB-enabled AP. Accordingly, the client device may not struggle in identifying and selecting the additional UWB-enabled APs for the subsequent ranging.

In numerous additional embodiments, the WLAN data 1428 may include a connectivity identifier of the client device or the UWB-enabled AP, a WLAN RSSI of the client device or the UWB-enabled AP and a WLAN RSSI threshold of the client device or the UWB-enabled AP. For instance, the connectivity identifier of the client device or the UWB-enabled AP may indicate a MAC address of a Wi-Fi interface (or a Bluetooth interface) of the client device or the UWB-enabled AP. For example, the WLAN RSSI of the client device or the UWB-enabled AP may represent a power level (or a signal strength) of a wireless signal received by the client device or the UWB-enabled AP. In an example, the WLAN RSSI threshold of the client device or the UWB-enabled AP may represent a specific RSSI value, beyond which a UWB channel of the client device or the UWB-enabled AP is reachable.

In a variety of embodiments, the UWB data 1430 may include a UWB identifier of the client device or the UWB-enabled AP and UWB channel information of the client device or the UWB-enabled AP. For example, the UWB identifier of the client device or the UWB-enabled AP may indicate a MAC address of a UWB interface (or a UWB device) of the client device or the UWB-enabled AP. The UWB channel information of the client device or the UWB-enabled AP may indicate the UWB channel of the client device or the UWB-enabled AP.

In various further embodiments, the ranging data 1432 may include a plurality of distances between the client device and the UWB-enabled AP, a plurality of WLAN RSSIs of the client device or the UWB-enabled AP, a plurality of correspondence relationships between the plurality of distances and the plurality of WLAN RSSIs, and the movement vector of the client device relative to the UWB-enabled AP. For example, each correspondence relationship of the plurality of correspondence relationships may indicate a specific distance of the plurality of distances is mapped to a respective WLAN RSSI of the plurality of WLAN RSSIs. In an example, the movement vector may include a radial speed vector indicating the speed at which the client device is moving either toward or away from the UWB-enabled AP.

In still further embodiments, the device 1400 can also include one or more input/output controllers 1416 for receiving and processing input from a number of input devices, such as a keyboard, a mouse, a touchpad, a touch screen, an electronic stylus, or other type of input device. Similarly, an input/output controller 1416 can be configured to provide output to a display, such as a computer monitor, a flat panel display, a digital projector, a printer, or other type of output device. Those skilled in the art will recognize that the device 1400 might not include all of the components shown in FIG. 14 and can include other components that are not explicitly shown in FIG. 14 or might utilize an architecture completely different than that shown in FIG. 14.

Finally, in numerous additional embodiments, data may be processed into a format usable by a machine-learning model 1426 (e.g., feature vectors), and or other pre-processing techniques. The machine-learning (“ML”) model 1426 may be any type of ML model, such as supervised models, reinforcement models, or unsupervised models. The ML model 1426 may include one or more of linear regression models, logistic regression models, decision trees, Naïve Bayes models, neural networks, k-means cluster models, random forest models, or other types of ML models 1426.

The ML model(s) 1426 can be configured to generate inferences to make predictions or draw conclusions from data. An inference can be considered the output of a process of applying a model to new data. This can occur by learning from at least the WLAN data 1428, the UWB data 1430, and the ranging data 1432 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1426 may be generated by human/administrator verifications or may compare predicted outcomes with actual outcomes. Further, when the device is configured as the UWB-enabled AP, the ML model(s) 1426 may be utilized to update a neighbor AP list associated with the UWB-enabled AP. In an example, the neighbor AP list may include information (e.g., connectivity identifiers, UWB identifiers, UWB channel information, or the like) about one or more neighboring UWB-enabled APs. Furthermore, the ML model(s) 1426 may be utilized to select a neighboring UWB-enabled AP from the updated neighbor AP list by learning the WLAN data 1428, the UWB data 1430, and/or the ranging data 1432.

Although a specific embodiment for a device 1400 suitable for configuration with the localization logic for carrying out the various steps, processes, methods, and operations described herein is discussed with respect to FIG. 14, any of a variety of systems and/or processes may be utilized in accordance with embodiments of the disclosure. For example, the device 1400 may correspond to a mobile computing device such as a laptop (or a smartphone), or may correspond to a network device such as an AP. The elements depicted in FIG. 14 may also be interchangeable with other elements of FIGS. 1-13 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network; and
a memory communicatively coupled to the processor, wherein the memory comprises a localization logic that is configured to:
perform an Ultra-Wideband (UWB) ranging operation against a client device; and
transmit, to the client device, an indication of a proposed handover to a first UWB-enabled Access Point (AP) for a subsequent UWB ranging operation.

2. The network device of claim 1, wherein the UWB ranging operation comprises a Two-Way Ranging (TWR) operation.

3. The network device of claim 1, wherein the UWB ranging operation comprises two or more rounds of ranging exchanges.

4. The network device of claim 3, wherein the localization logic is further configured to determine a movement vector of the client device relative to the network device based on the two or more rounds of ranging exchanges.

5. The network device of claim 1, wherein the localization logic is further configured to determine at least one distance between the client device and the network device based on the UWB ranging operation.

6. The network device of claim 5, wherein the localization logic is further configured to:
measure at least one Wireless Local Area Network (WLAN) Received Signal Strength Indicator (RSSI) associated with the client device; and
establish a correspondence relationship between the at least one WLAN RSSI associated with the client device and the at least one distance between the client device and the network device.

7. The network device of claim 1, wherein the indication of the proposed handover is transmitted via a Wireless Local Area Network (WLAN) action frame.

8. The network device of claim 1, wherein the indication of the proposed handover comprises a UWB identifier associated with the first UWB-enabled AP.

9. The network device of claim 8, wherein the indication of the proposed handover further comprises an indication of a Wireless Local Area Network (WLAN) Received Signal Strength Indicator (RSSI) threshold.

10. The network device of claim 1, wherein the localization logic is further configured to:
compile a neighbor AP list based on a Neighbor Discovery Protocol (NDP); and
select the first UWB-enabled AP from the neighbor AP list for the proposed handover.

11. The network device of claim 10, wherein the localization logic is further configured to:
receive, from the client device, an indication of a failure of the proposed handover to the first UWB-enabled AP;
update the neighbor AP list based on the failure of the proposed handover to the first UWB-enabled AP;
select a second UWB-enabled AP from the updated neighbor AP list; and
transmit, to the client device, an indication of an additional proposed handover to the second UWB-enabled AP for the subsequent UWB ranging operation.

12. The network device of claim 10, wherein the localization logic is further configured to:
determine a success of the proposed handover of the client device to the first UWB-enabled AP based on an absence of an indication of a failure of the proposed handover; and
update the neighbor AP list based on the success of the proposed handover to the first UWB-enabled AP.

13. The network device of claim 10, wherein the localization logic is further configured to utilize a machine learning process to update the neighbor AP list and select one or more further UWB-enabled APs from the updated neighbor AP list for one or more further proposed handovers.

14. The network device of claim 1, wherein the network device comprises a UWB-enabled AP.

15. A client device, comprising:
a processor;
a network interface controller configured to provide access to a network; and
a memory communicatively coupled to the processor, wherein the memory comprises a localization logic that is configured to:
detect a presence of a first Ultra-Wideband (UWB)-enabled Access Point (AP);
perform a UWB ranging operation against the first UWB-enabled AP; and
receive an indication of a proposed handover to a second UWB-enabled AP for a subsequent UWB ranging operation from the first UWB-enabled AP.

16. The client device of claim 15, wherein the localization logic is further configured to receive an indication of the first UWB-enabled AP via an Out of Band (OOB) process.

17. The client device of claim 16, wherein the indication of the first UWB-enabled AP comprises a UWB identifier associated with the first UWB-enabled AP and an indication of a Wireless Local Area Network (WLAN) Received Signal Strength Indicator (RSSI) threshold, wherein the localization logic is further configured to:
measure one or more WLAN RSSIs associated with the first UWB-enabled AP; and
compare each of the measured one or more WLAN RSSIs associated with the first UWB-enabled AP to the WLAN RSSI threshold, and wherein the UWB ranging operation is performed in response to at least one of the measured one or more WLAN RSSIs associated with the first UWB-enabled AP being greater than the WLAN RSSI threshold.

18. The client device of claim 15, wherein the localization logic is further configured to:
perform the subsequent UWB ranging operation against the second UWB-enabled AP based on the indication of the proposed handover; and
receive an indication of a subsequent proposed handover to a third UWB-enabled AP for a next UWB ranging operation from the second UWB-enabled AP.

19. The client device of claim 15, wherein the localization logic is further configured to:
attempt to perform the subsequent UWB ranging operation against the second UWB-enabled AP based on the indication of the proposed handover, wherein the attempt results in a failure;
transmit, to the first UWB-enabled AP, an indication of the failure of the proposed handover to the second UWB-enabled AP; and
receive an indication of an additional proposed handover to a third UWB-enabled AP for the subsequent UWB ranging operation from the first UWB-enabled AP based on the indication of the failure of the proposed handover to the second UWB-enabled AP.

20. A method for handing over a client device, comprising:
performing an Ultra-Wideband (UWB) ranging operation against the client device; and
transmitting, to the client device, an indication of a proposed handover to a UWB-enabled Access Point (AP) for a subsequent UWB ranging operation.
